(19) United States
(12) Patent Application Publication
(10) Pub. No.: US 2024/0353899 A1
(43) Pub. Date: Oct. 24, 2024

(54) ELECTRONIC DEVICE

(71) Applicant: Semiconductor Energy Laboratory Co., Ltd., Atsugi-shi (JP)

(72) Inventors: Shunpei YAMAZAKI, Setagaya (JP); Yosuke TSUKAMOTO, Atsugi (JP); Yoshiaki OIKAWA, Atsugi (JP)

(21) Appl. No.: 18/633,709

(22) Filed: Apr. 12, 2024

(30) Foreign Application Priority Data
Apr. 21, 2023 (JP) 2023-069961

(51) Int. Cl. G06F 1/16; G06F 3/041

(52) U.S. Cl. CPC G06F 1/1652; G06F 1/1641; G06F 1/1656; G06F 3/0412; G06F 2203/04105

(57) ABSTRACT

A display device or an electronic device in which the number of components can be reduced can be provided. An electronic device in which a space in a housing can be effectively used can be provided. A display panel includes a first display portion positioned on the front surface of the housing, a second display portion and a third display portion that are provided along adjacent two of the side surfaces of the housing, and a first portion that is folded back to the rear side of the first display portion. When the display panel is developed, the first portion faces the first display portion with the second display portion provided therebetween. The first portion includes an external connection terminal or a driver circuit.

### BACKGROUND OF THE INVENTION

### 1. Field of the Invention

One embodiment of the present invention relates to a display device. One embodiment of the present invention relates to an electronic device including a display device.

One embodiment of the present invention is not limited to the above technical field. Examples of the technical field of one embodiment of the present invention disclosed in this specification and the like include a semiconductor device, a display device, a light-emitting device, a power storage device, a memory device, an electronic device, a lighting device, an input device, an input/output device, a driving method thereof, and a manufacturing method thereof. A semiconductor device generally means a device that can function by utilizing semiconductor characteristics.

### 2. Description of the Related Art

A flexible display that can be curved by being provided with a display element and a driver circuit over a substrate with flexibility has been put to practical use. A flexible display is thin and light in weight and thus suitable for portable information terminals such as smartphones.

Patent Document 1 discloses a structure in which part of a display device with flexibility is curved so that a connection terminal is folded back to a side opposite to a display surface.

### REFERENCE

[Patent Document 1] Japanese Published Patent Application No. 2014-197181

### SUMMARY OF THE INVENTION

An object of one embodiment of the present invention is to provide a display device or an electronic device in which the number of components can be reduced. Another object is to provide an electronic device in which a space in a housing can be effectively used. Another object is to provide an electronic device that can be reduced in thickness. Another object is to provide a display device or an electronic device in which a display region can be enlarged. Another object is to provide a display device or an electronic device that can perform various display methods.

Another object of one embodiment of the present invention is to provide a novel semiconductor device, a novel display device, or a novel electronic device. Another object of one embodiment of the present invention is to at least alleviate at least one of problems in the conventional art.

Note that the description of these objects does not preclude the existence of other objects. One embodiment of the present invention does not need to achieve all of these objects. Other objects can be derived from the description of the specification, the drawings, the claims, and the like.

One embodiment of the present invention is an electronic device including a housing and a display panel having flexibility and provided in the housing. The display panel includes a first display portion, a second display portion, a third display portion, and a first portion. The first display portion is on a front surface of the housing. The second display portion is seamlessly continuous with the first display portion and is on a first side surface of the housing. The third display portion is seamlessly continuous with the first display portion and is on a second side surface of the housing that is adjacent to the first side surface. The first portion faces the first display portion with the second display portion provided therebetween when the display panel is developed and is folded back to a back side of the first display portion. Furthermore, the first portion includes a terminal portion.

Another embodiment of the present invention is an electronic device including a housing and a display panel having flexibility and provided in the housing. The display panel includes a first display portion, a second display portion, a third display portion, and a first portion. The first display portion is on a front surface of the housing. The second display portion is seamlessly continuous with the first display portion and is on a first side surface of the housing. The third display portion is seamlessly continuous with the first display portion and is on a second side surface of the housing that is adjacent to the first side surface. The first portion faces the first display portion with the second display portion provided therebetween when the display panel is developed and is folded back to a back side of the first display portion. Furthermore, the first portion includes a circuit portion.

In the above embodiment, the circuit portion preferably includes one or more of a shift register circuit, a demultiplexer circuit, a latch circuit, and a level shifter circuit.

In the above embodiment, the circuit portion preferably includes a signal line driver circuit.

In any of the above embodiments, the display panel preferably includes a fourth display portion. In that case, the fourth display portion is seamlessly continuous with the first display portion and is on a third side surface of the housing that is opposite to the first side surface and adjacent to the second side surface.

In any of the above embodiments, the display panel preferably includes a fifth display portion. In that case, the fifth display portion is seamlessly continuous with the first display portion and is on a fourth side surface of the housing that is opposite to the second side surface and adjacent to the first side surface.

In any of the above embodiments, it is preferable that the second display portion include a portion curved with a first curvature, and the third display portion include a portion curved with a second curvature. Furthermore, it is preferable that the first curvature be different from the second curvature. Alternatively, it is preferable that the first curvature be larger than the second curvature.

In any of the above embodiments, the first portion preferably includes a portion fixed to a rear surface of the first display portion.

In the above embodiment, the first display portion preferably includes a first pixel region, a second pixel region, and a third pixel region. In that case, it is preferable that the first pixel region include a plurality of pixels, the second pixel region include a plurality of pixels and a scan line driver circuit, and the third pixel region include a plurality of pixels and a signal line driver circuit.

In any of the above embodiments, the first display portion preferably includes a first pixel region and a second pixel region. In that case, it is preferable that the first pixel region include a plurality of pixels, and the second pixel region include a plurality of pixels and a scan line driver circuit.

In any of the above embodiments, the first portion preferably includes a sensor portion. In that case, the sensor portion preferably includes a pressure-sensitive sensor. Furthermore, the first portion preferably includes a portion fixed so that the sensor portion is on a rear surface of the first display portion.

In the above embodiment, a radiator plate is preferably included in the housing. In that case, the radiator plate is preferably bonded to the first portion with a thermally conductive adhesive material.

Furthermore, in the above embodiment, a battery is preferably included in the housing. In that case, the battery is preferably bonded to the radiator plate with a thermally conductive adhesive material.

In any of the above embodiments, the first display portion preferably includes a plurality of pixels. In that case, each of the pixels includes a display element and a transistor. Furthermore, it is preferable that the transistor include an oxide semiconductor in a semiconductor layer where a channel is formed, and wherein a source and a drain of the transistor be at different heights.

In the above embodiment, the first display portion preferably includes a plurality of pixels. In that case, each of the pixels preferably includes a display element and a first transistor. In addition, the circuit portion preferably includes a second transistor. It is preferable that each of the first transistor and the second transistor include an oxide semiconductor in a semiconductor layer where a channel is formed, and a source and a drain of each of the first transistor and the second transistor be at different heights.

According to one embodiment of the present invention, a display device or an electronic device in which the number of components can be reduced can be provided. An electronic device in which a space in a housing can be effectively used can be provided. An electronic device that can be reduced in thickness can be provided. A display device or an electronic device in which a display region can be enlarged can be provided. A display device or an electronic device that can perform various display methods can be provided.

According to one embodiment of the present invention, a novel semiconductor device, a novel display device, a novel electronic device, or a novel display system can be provided. According to one embodiment of the present invention, at least one of problems in the conventional art can be at least alleviated.

Note that the description of these effects does not preclude the existence of other effects. One embodiment of the present invention does not necessarily have all of these effects. Other effects can be derived from the description of the specification, the drawings, the claims, and the like.

### BRIEF DESCRIPTION OF THE DRAWINGS

In the accompanying drawings:

FIGS. 1A to 1C illustrate a structure example of an electronic device;

FIGS. 2A to 2C illustrate a structure example of an electronic device;

FIGS. 3A to 3D illustrate structure examples of an electronic device;

FIGS. 4A to 4D illustrate structure examples of an electronic device;

FIGS. 5A to 5D illustrate structure examples of an electronic device;

FIGS. 6A and 6B illustrate a structure example of an electronic device;

FIGS. 7A to 7D illustrate structure examples of an electronic device;

FIGS. 8A to 8D illustrate structure examples of an electronic device;

FIGS. 9A to 9D illustrate structure examples of an electronic device;

FIG. 10 illustrates a structure example of a display device;

FIGS. 11A and 11B illustrate a structure example of a display device;

FIGS. 12A and 12B illustrate a structure example of a semiconductor device;

FIG. 13 illustrates a structure example of a display device;

FIG. 14 illustrates a structure example of a display device;

FIG. 15 illustrates a structure example of a display device;

FIG. 16 illustrates a structure example of a display device;

FIG. 17 illustrates a structure example of a display device; and

FIGS. 18A to 18F illustrate a method for manufacturing a display device.

### DETAILED DESCRIPTION OF THE INVENTION

Embodiments will be described below with reference to the drawings. Note that the embodiments can be implemented with many different modes, and it will be readily understood by those skilled in the art that modes and details thereof can be changed in various ways without departing from the spirit and scope thereof. Therefore, the present invention should not be construed as being limited to the description of embodiments below.

Note that in structures of the invention described below, the same portions or portions having similar functions are denoted by the same reference numerals in different drawings, and the description thereof is not repeated. The same hatching pattern is used for portions having similar functions, and the portions are not denoted by specific reference numerals in some cases.

Note that in each drawing described in this specification, the size, the layer thickness, or the region of each component is exaggerated for clarity in some cases. Therefore, the size, the layer thickness, or the region is not limited to the illustrated scale.

Note that in this specification and the like, ordinal numbers such as “first” and “second” are used in order to avoid confusion among components and do not limit the number of components.

In this specification and the like, a display panel that is one embodiment of a display device has a function of displaying (outputting) an image or the like on (to) a display surface. Thus, the display panel is one embodiment of an output device.

In this specification and the like, a structure in which a connector such as a flexible printed circuit (FPC) or a tape carrier package (TCP) is attached to a substrate of a display panel, or a structure in which an IC is mounted on a substrate by a chip on glass (COG) method or the like is referred to as a display panel module or a display module, or simply referred to as a display panel or the like in some cases.

Note that in this specification and the like, a touch panel that is one embodiment of a display device has a function of displaying an image or the like on a display surface and a function of a touch sensor capable of sensing the contact, press, approach, or the like of a sensing target such as a finger or a stylus with or to the display surface. Therefore, the touch panel is one embodiment of an input/output device.

A touch panel can also be referred to as, for example, a display panel (or a display device) with a touch sensor or a display panel (or a display device) having a touch sensor function. A touch panel can include a display panel and a touch sensor panel. Alternatively, a touch panel can have a function of a touch sensor inside a display panel or on a surface thereof.

In this specification and the like, a structure in which a connector or an IC is attached to a substrate of a touch panel is referred to as a touch panel module or a display module, or simply referred to as a touch panel or the like in some cases.

### Embodiment 1

In this embodiment, structure examples of a display panel and an electronic device including the display panel of embodiments of the present invention will be described.

One embodiment of the present invention includes a flexible display panel. The display panel in the state of being partly curved is provided inside a housing of an electronic device. The display panel can display an image also on the curved portion.

Specifically, for example, the display panel can have a structure including a first display portion positioned on the front surface of the housing, a second display portion and a third display portion that are provided along adjacent two of the side surfaces of the housing, and a first portion that is folded back to the rear side of the first display portion (the side opposite to the display surface). The first display portion and the second display portion can perform display continuously and seamlessly. The same applies to the first display portion and the third display portion.

When the display panel is developed, the first portion faces the first display portion with the second display portion provided therebetween. The first portion is provided with a terminal portion including a plurality of external connection terminals for supplying power, signals, and the like to the display panel. A flexible printed circuit (FPC), a cable, a connector, an IC, or the like can be connected to the terminal portion.

As described above, it is preferable that the first portion not be provided adjacent to the first display portion but be provided so that the second display portion is sandwiched between the first portion and the first display portion. In the case where the second display portion is not provided, the first portion needs to be curved at approximately 180° with a small radius of curvature. When the radius of curvature is small and the angle of the curve is large, a crack might be generated in a film included in the display panel to affect the reliability of the display panel. In contrast, in the case where the second display portion is provided, an interface between the first display portion and the second display portion, the vicinity of the interface, or the second display portion itself is curved; therefore, the curved portion can be distributed, and high reliability can be achieved.

In addition, a driver circuit for driving the display panel is preferably provided in the first portion. For example, a signal line driver circuit (also referred to as a source driver), a scan line driver circuit (also referred to as a gate driver), or parts of them can be provided. For example, one or more of a shift register circuit, a demultiplexer circuit, a latch circuit, and a level shifter circuit included in the signal line driver circuit are preferably provided.

Furthermore, it is preferable that transistors included in a circuit provided in the first portion and transistors included in a circuit provided in pixels of the first display portion or the like be formed through the same manufacturing process. In particular, as the transistor, a transistor in which an oxide semiconductor is used as a semiconductor where its channel is formed is preferably used. Furthermore, it is preferable to use a vertical transistor in which the source and the drain are positioned at different heights. In that case, an extremely high switching characteristics can be achieved; thus, high driving performance can be achieved in not only a pixel circuit but also the above-described driver circuit. For example, it is possible to obtain a display panel where pixels, a gate driver, and a source driver are mounted without using an IC.

For example, there may be a difference in wiring width between a mass-production apparatus for flat panel displays and a mass-production apparatus for LSIs by two digits or more. Therefore, when a circuit is integrally formed in the first portion, the area of the first portion is larger than that in the case of mounting an IC. However, since the first portion can be folded back to the rear surface (back surface) side of the first display portion, the occupied space in the housing can be reduced. Furthermore, part or the whole of the driver circuit of the display panel can be placed in a circuit portion, so that the number of components of the display module can be reduced.

More specific examples are described below with reference to drawings.

### Structure Example 1

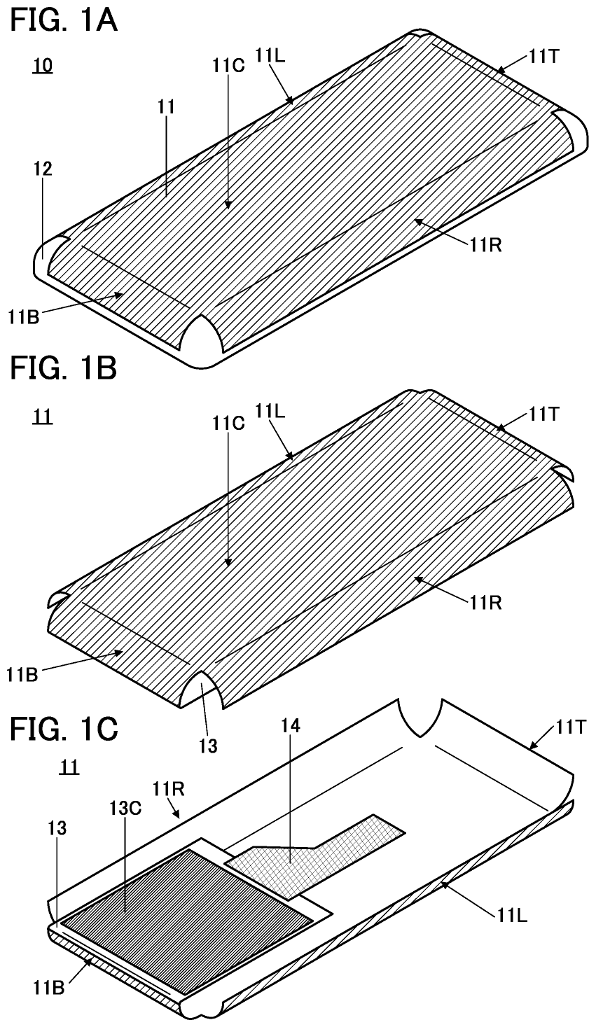

FIG. 1A is a schematic perspective view of an electronic device 10. The electronic device 10 includes a housing 12 and a display module 11 incorporated in the housing 12. The electronic device 10 can be used as a portable information terminal such as a smartphone. Note that components such as a camera, a physical button, and an external connection terminal are omitted in FIG. 1A. These components can be placed in a portion where the display module 11 of the housing 12 is not provided or placed to overlap with the display module 11.

The display module 11 includes a display portion 11C positioned on the front surface of the housing 12. Furthermore, the display module 11 includes a display portion 11R positioned on the right side surface with respect to the front surface of the housing 12 when the front surface of the housing 12 is set in a portrait orientation, a display portion 11L positioned on the left side surface, a display portion 11T positioned on the upper side surface, and a display portion 11B positioned on the lower side surface (also referred to as a bottom surface).

A plurality of pixels arranged in a matrix form are provided in each of the display portions 11C, 11R, 11L, 11T, and 11B. Each of the pixels is provided with at least one display element and at least one transistor. The display portions 11R, 11L, 11T, and 11B are each seamlessly continuous with the display portion 11C, and can display a seamless image together with the display portion 11C. Note that display portions that are continuous seamlessly may be rephrased as a state where pixels, display elements, and transistors are provided at the same intervals on the same plane in two adjacent display portions, for example.

Since the display portion 11C is seamlessly continuous with the display portions 11R, 11L, 11T, and 11B, their boundaries cannot be determined exactly in some cases. For example, when the display portion 11C is flat, a straight line (or curved line) connecting points where the curvature changes can be regarded as the boundary between the display portion 11C and each of the display portions 11R, 11L, 11T, and 11B.

Each of the display portions 11R, 11L, 11T, and 11B is provided to be curved along a curved surface positioned on the side surface of the housing 12. Note that the structure is not limited thereto; each of the display portions 11R, 11L, 11T, and 11B may have a flat surface.

FIGS. 1B and 1C are schematic perspective views of the display module 11. FIG. 1B illustrates the front surface, the right side surface, and the bottom surface, and FIG. 1C illustrates the back surface, the left side surface, and the bottom surface. These figures show the shape of the display module 11 that is to be incorporated in the housing 12. The display module 11 includes a display panel and an FPC 14. The display panel corresponds to a portion other than the FPC 14 of the display module 11 and includes the display portions 11C, 11T, 11B, 11L, and 11R, a non-display portion 13, a connection portion with the FPC 14, and the like.

The display module 11 includes the non-display portion 13 adjacent to the display portion 11B. The non-display portion 13 is folded so as to overlap with the rear side of the display portion 11C. The non-display portion 13 includes a circuit portion 13C and a connection portion for connection with the FPC 14. Note that a region (display portion) capable of displaying an image can be placed on part or the whole of the non-display portion 13. When part or the whole of the non-display portion 13 is a display portion, the display area can be increased.

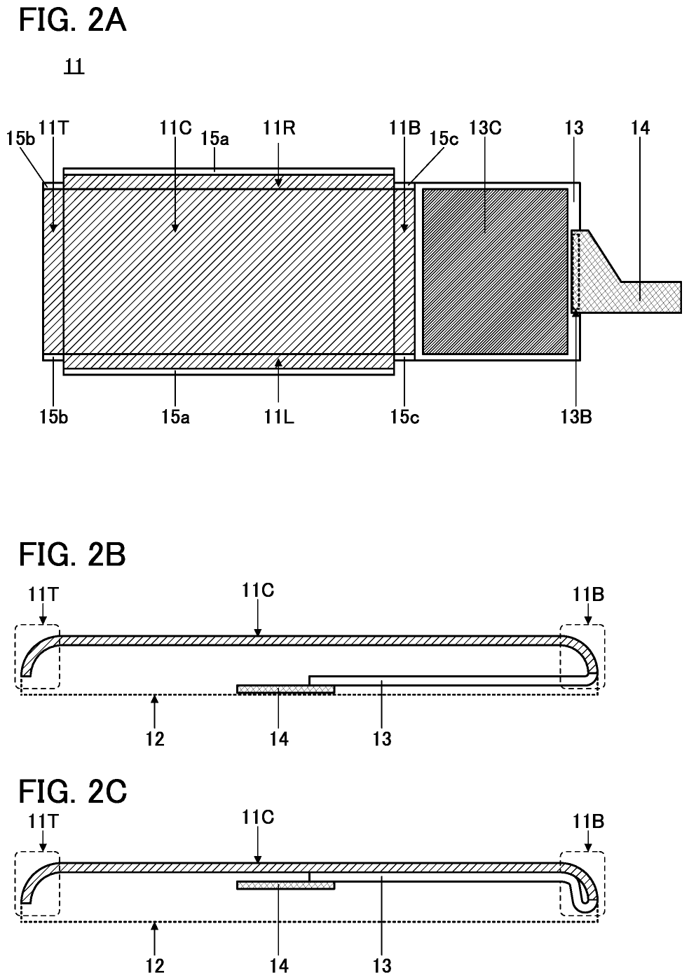

FIG. 2A illustrates a plan view of the display module 11 developed. The display portions 11R, 11L, 11T, and 11B are provided around the display portion 11C. The non-display portion 13 is provided to face the display portion 11C with the display portion 11B provided therebetween. A terminal portion 13B for connection with the FPC 14 is provided at an end portion of the non-display portion 13. The terminal portion 13B is connected to the FPC 14 with, for example, an anisotropic conductive sheet or an anisotropic conductive paste.

The circuit portion 13C includes a driver circuit for driving pixels provided in each of the display portions. The circuit portion 13C can include, for example, part or the whole of a scan line driver circuit or part or the whole of a signal line driver circuit. For example, the circuit portion 13C preferably includes one or more of a shift register circuit, a demultiplexer circuit, a latch circuit, and a level shifter circuit.

FIG. 2A illustrates an example including circuit portions 15a, 15b, and 15c that function as scan line driver circuits. The circuit portions 15a are placed along the long sides of the display portions 11R and 11L and control the driving of the display portions 11C, 11R, and 11L. The circuit portions 15b and 15c are placed along the short sides of the display portions 11T and 11B, respectively, and control the driving of the display portions 11T and 11B, respectively. Thus, the circuit portion 13C does not have a function of a scan line driver circuit and is configured to include part or the whole of a signal line driver circuit.

The circuit portion 13C preferably includes transistors formed through the same process as transistors included in the display portion 11C and the like. In that case, an extremely large cost reduction can be achieved as compared with the case of mounting an IC for the driver circuit, which is separately formed, by bonding or the like. In particular, in the case where a signal line driver circuit is mounted on the circuit portion 13C, it is preferable to use transistors that have high switching characteristics, i.e., that are capable of making large current flow and also capable of high-speed switching operation.

For example, crystalline silicon such as single crystal silicon or polycrystalline silicon can be used for the semiconductor layer of the transistor. Alternatively, an oxide semiconductor can be used for the semiconductor layer of the transistor. As for the transistor structure, it is possible to use a transistor in which the semiconductor layer is provided in a planar shape, what is called a planar transistor, but it is preferable to use a transistor in which the source and the drain are arranged at different heights, what is called a vertical transistor. The channel length of such a vertical transistor can be made extremely short regardless of the limitation of resolution due to a light exposure apparatus. Thus, combining a vertical transistor with a high mobility semiconductor material such as crystalline silicon or an oxide semiconductor makes it possible to achieve a transistor with extremely high switching characteristics. In particular, an oxide semiconductor is preferable because the manufacturing cost of an oxide semiconductor is lower than that of crystalline silicon and an oxide semiconductor can be stably formed in a large area.

FIG. 2B is a schematic cross-sectional view of the electronic device 10 taken along the longitudinal direction. Only the housing 12 and the display module 11 are illustrated and the other components (e.g., a circuit board and a battery) are omitted in FIG. 2B.

The housing 12 has a curved shape from the top surface (front surface) toward the side surfaces. The display portions 11T and 11B are provided along the curved side surfaces. The non-display portion 13 adjacent to the display portion 11B is curved with a larger curvature than the display portion 11B and is folded back to overlap with the display portion 11C. The cross sections of the display portions 11T and 11B are each an arc with approximately 90°. Note that the display portions 11R and 11L can each have the same shape as the display portions 11T and 11B also.

Note that as illustrated in FIG. 2C, the non-display portion 13 may be fixed to the back surface of the display portion 11C of the display module 11. In FIG. 2C, the non-display portion 13 is fixed to the back surface of the display portion 11C with an adhesive tape or the like not illustrated, for example. Storing the non-display portion 13 in the space on the back of the display module 11 in this manner enables further effective use of the space in the housing 12. As a result, the size or thickness of the electronic device 10 can be reduced. Alternatively, a large number of ICs or modules can be placed in the limited space in the housing 12, which allows the electronic device 10 to be multifunctional.

### Structure Example 2

Structure examples different from Structure Example 1 are described below. Note that portions similar to those described in Structure Example 1 are not described in some cases.

### Structure Example 2-1

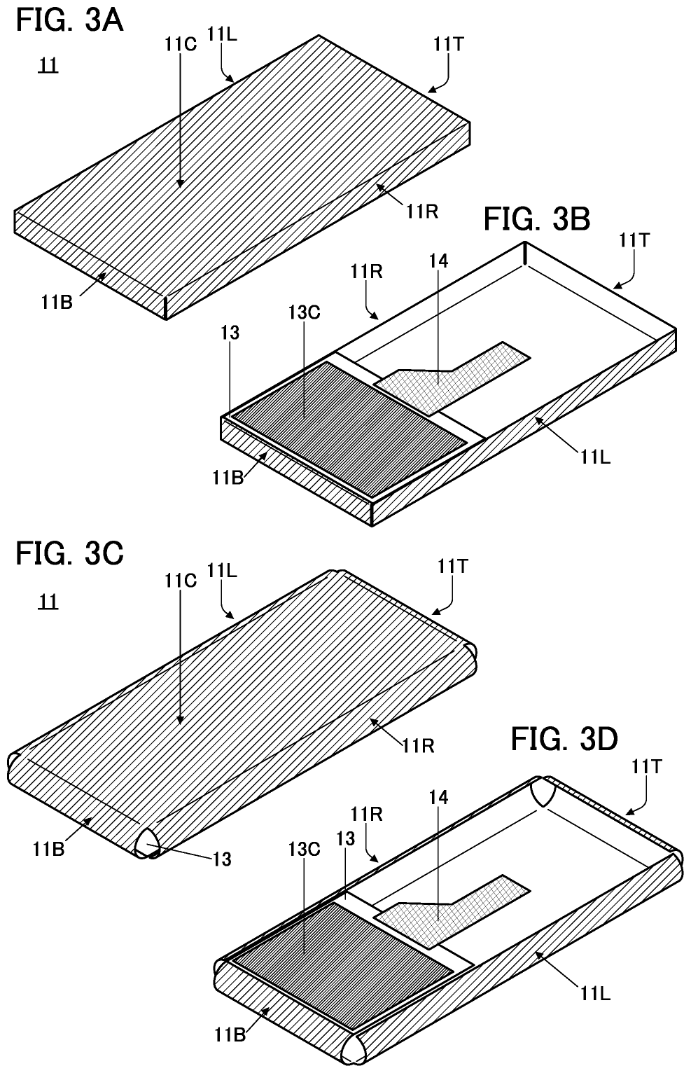

FIGS. 3A and 3B are perspective views of a display module described below as an example. FIG. 3A illustrates the front surface, the right side surface, and the bottom surface of the display module, and FIG. 3B illustrates the back surface, the left side surface, and the bottom surface of the display module. The structure illustrated in FIGS. 3A and 3B is different from the above structure example mainly in the shapes of the display portions 11R, 11L, 11T, and 11B.

Each of the display portions 11R, 11L, 11T, and 11B includes a curved portion and a flat portion and is configured so that the curvature of the curved portion is larger (the radius of curvature is smaller) than that in Structure Example 1. For example, the radii of curvature of these curved portion are each preferably greater than or equal to 0.05 mm and less than or equal to 1 mm, further preferably greater than or equal to 0.1 mm and less than or equal to 0.8 mm, still further preferably greater than or equal to 0.1 mm and less than or equal to 0.6 mm, yet still further preferably greater than or equal to 0.1 mm and less than or equal to 0.5 mm, yet still further preferably greater than or equal to 0.1 mm and less than or equal to 0.3 mm. When the radius of curvature of the curved portion is small, an image can be displayed on the front and side surfaces of the electronic device without a gap, so that a display device with excellent design quality can be obtained.

### Structure Example 2-2

A structure illustrated in FIGS. 3C and 3D is different from the above structure examples mainly in the shapes of the display portions 11R, 11L, 11T, and 11B.

The cross sections of the display portions 11R, 11L, 11T, and 11B are each an arc with approximately 90° in Structure Example 1, whereas the cross sections of the display portions 11R, 11L, 11T, and 11B are each an arc with approximately 180° in the example illustrated in FIGS. 3C and 3D. Such a structure allows an image to be seen at any angle with respect to the electronic device, enabling the electronic device to have high convenience and excellent designability.

### Structure Example 2-3

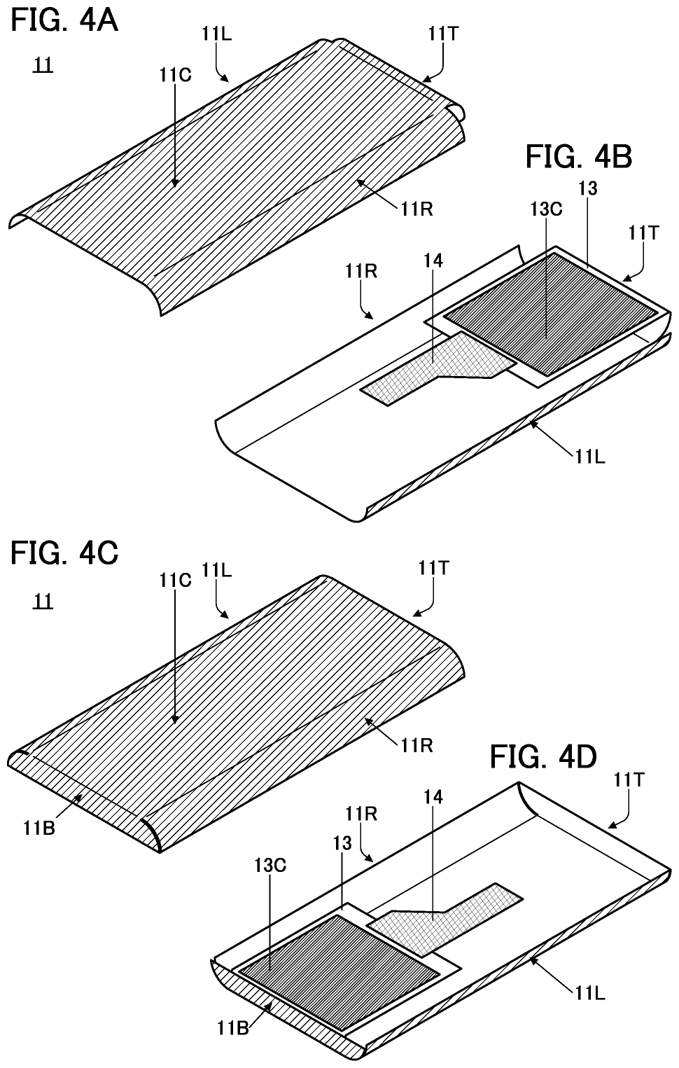

A structure illustrated in FIGS. 4A and 4B is different from the above structure examples mainly in not including the display portion 11B.

Display portions are not arranged on all the four side surfaces of the housing 12 but a side surface with no display portion is provided, whereby a space for placing an external connection terminal, a physical button, and the like can be ensured. For example, in the structure illustrated in FIGS. 4A and 4B, an external connection terminal can be placed on the bottom surface side of the housing 12. Although the display portion 11B is not provided in the example described here, one to three of the display portions 11R, 11L, 11T, and 11B can be omitted.

Since the display portion 11B is not included in the example, the non-display portion 13 is provided adjacent to the display portion 11T.

### Structure Example 2-4

The structure illustrated in FIGS. 4C and 4D is different from Structure Example 1 mainly in the shapes of the display portions 11B and 11T.

FIGS. 4C and 4D illustrate an examples where the curvatures of the curved portions of the display portions 11B and 11T are larger (the radii of curvatures of the curved portions of the display portions 11B and 11T are smaller) than those of the curved portions of the display portions 11L and 11R. In each of the display portions 11B and 11T, the length of a side opposite to an interface with the display portion 11C is longer than the length of the interface. Such a shape allows an image to be displayed on all the surfaces except for the back surface of the housing 12, enabling the electronic device to have excellent designability.

### Structure Example 2-5

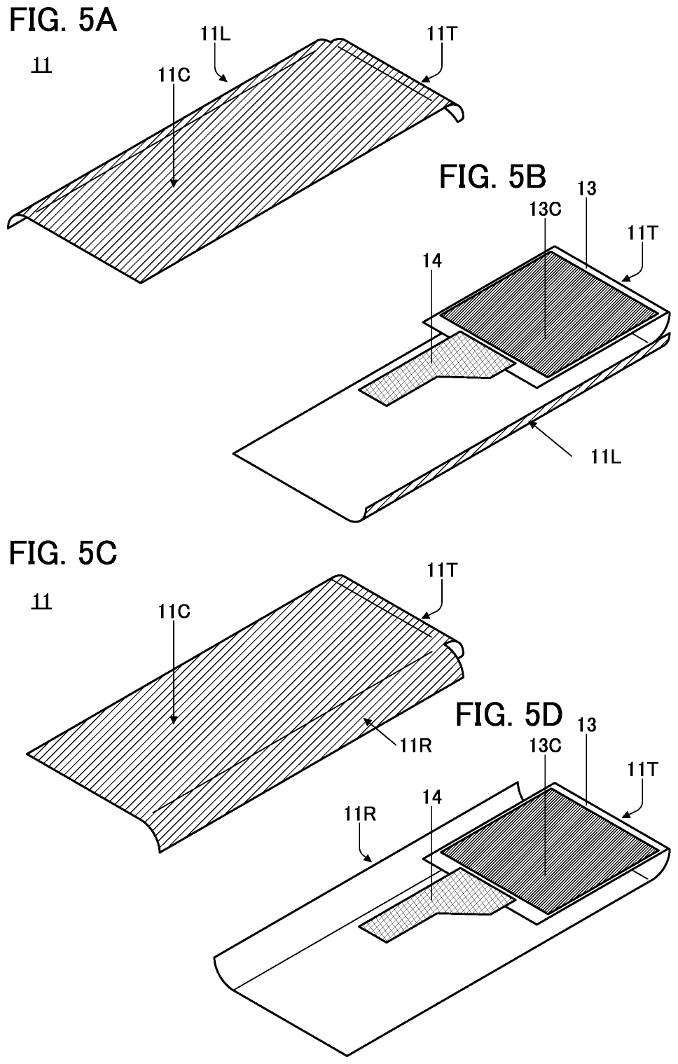

A structure illustrated in FIGS. 5A and 5B is different from Structure Example 1 mainly in not including the display portion 11B or the display portion 11R. A structure illustrated in FIGS. 5C and 5D is an example not including the display portion 11B or the display portion 11L.

As described above, the structure can be employed in which the display portions are placed on two adjacent side surfaces of the four side surfaces of the housing 12 and the other two side surfaces are exposed. In that case, it is preferable to place a physical button on a side surface along the longitudinal direction so that the physical button is easy to touch with a finger when the housing 12 is held. On the other hand, a side surface along the lateral direction is difficult to touch with a finger when the housing 12 is held; thus, it is preferable that, for example, an external connection terminal for connecting with a cable of a power supply or earphones be placed on the side surface to avoid the cable from becoming an obstacle in use.

### Structure Example 2-6

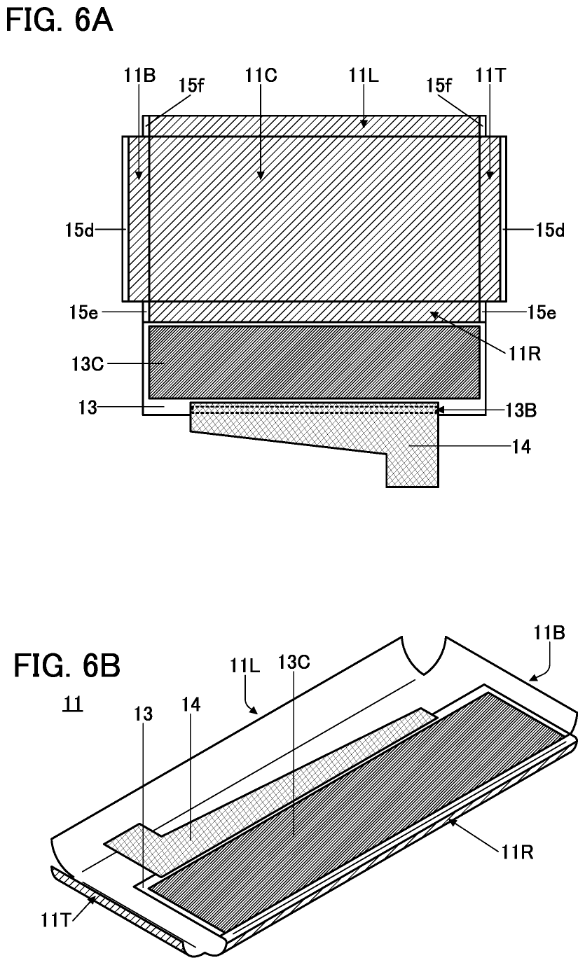

A structure illustrated in FIGS. 6A and 6B is an example in which the non-display portion 13 is provided to be adjacent to a display portion positioned on a side surface of the housing 12 in the longitudinal direction. In that case, the non-display portion 13 is provided to be adjacent to the display portion 11R. The circuit portion 15d functioning as a scan line driver circuit is provided to be adjacent to each of the display portions 11B and 11T. A pair of circuit portions 15f and a pair of circuit portions 15e are provided adjacent to the display portions 11L and 11R, respectively.

Such a structure allows the width of the terminal portion 13B to be increased. Accordingly, a terminal provided in the terminal portion 13B can be made large, and thus a connection defect with the FPC 14 and the like can be reduced. In addition, the number of terminals provided in the terminal portion 13B can be increased, and thus the number of signals input from the outside can be increased; therefore, a circuit used in the circuit portion 13C can be simplified.

### Structure Example 3

Structure Examples different from Structure Example 1 and Structure Example 2 described above will be described below.

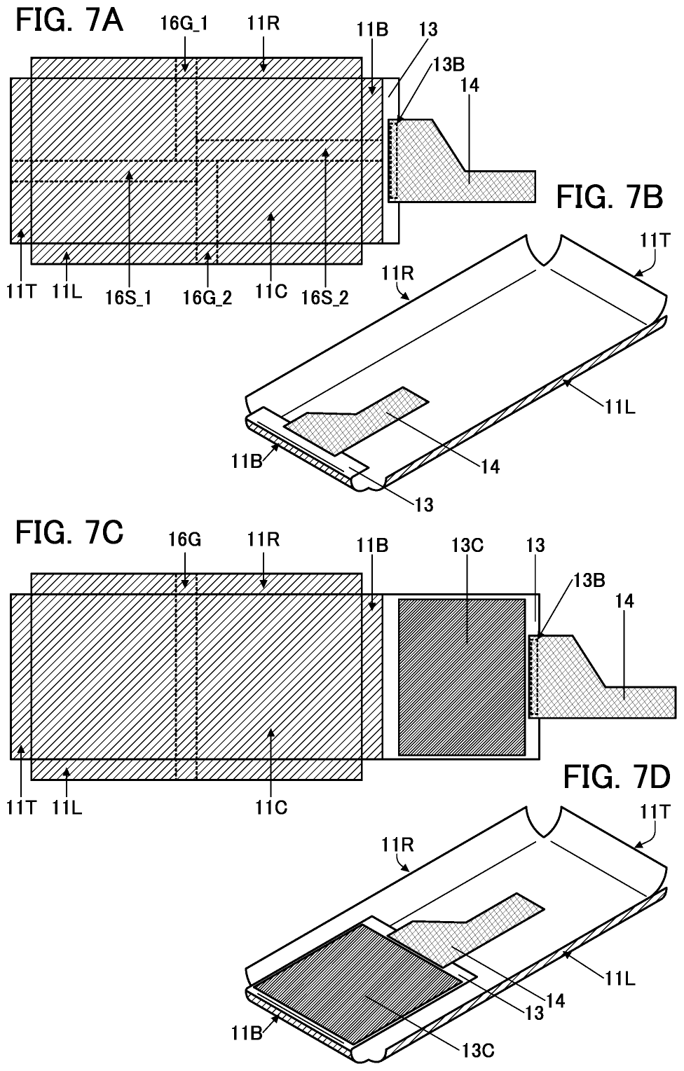

FIGS. 7A and 7B illustrate an example in which the circuit portion 13C is not included in the non-display portion 13. Furthermore, in the example, a scan line driver circuit and a signal line driver circuit are provided in a display portion. Specifically, the display portion includes a pixel region where only pixels are placed, a pixel region where pixels and a scan line driver circuit are placed, and a pixel region where pixels and a signal line driver circuit are placed.

Here, regions where the display portions 11C, 11R, 11L, 11T, and 11B are provided are collectively referred to as a display portion 11A. Regions 16G_1 and 16G_2 including scan line driver circuits and regions 16S_1 and 16S_2 including signal line driver circuits are provided in the display portion 11A.

The region 16G_1 is provided to overlap with the display portions 11R and 11C, and the region 16G_2 is provided to overlap with the display portions 11C and 11L. The region 16S_1 is provided to overlap with the display portions 11T and 11C, and the region 16S_2 is provided to overlap with the display portions 11C and 11B. The regions 16G_1, 16G_2, 16S_1, and 16S_2 are provided so as not to overlap with one another.

Although the region including the scan line driver circuit and the region including the signal line driver circuit are each divided into two so that they do not overlap with each other in the example, the structure is not limited thereto; the region including the scan line driver circuit and the region including the signal line driver circuit may each be divided into three or more.

Each of the regions 16G_1, 16G_2, 16S_1, and 16S_2 is provided with a pixel circuit and a driver circuit. For example, transistors, wirings, and the like included in the driver circuit are provided in spaces where transistors, wirings, and the like included in the pixel circuit are not provided. For example, a circuit corresponding to one scan line or one signal line is provided by utilizing a space between regions where a plurality of pixels are provided along the extending direction of the scan line or the signal line.

Here, when vertical transistors are used as transistors provided in each display portion, not only an improvement in switching performance of the transistors but also a reduction in area occupied by the transistors can be achieved, which makes it possible to mount a driver circuit on a display portion even in a high-resolution display module.

Alternatively, one of the scan line driver circuit and the signal line driver circuit may be placed in the display portion 11A, and the other may be placed in the non-display portion 13. FIGS. 7C and 7D illustrate an example in which the scan line driver circuit is placed in the display portion 11A and the signal line driver circuit is placed in the non-display portion 13.

In FIG. 7C, a region 16G including the scan line driver circuit is provided across the display portions 11R, 11C, and 11L. In addition, the signal line driver circuit is provided in the circuit portion 13C provided in the non-display portion 13. Such a structure makes design easier because the region 16G does not need to be divided, and thus is preferable.

### Structure Example 4

An electronic device including a sensor will be described below.

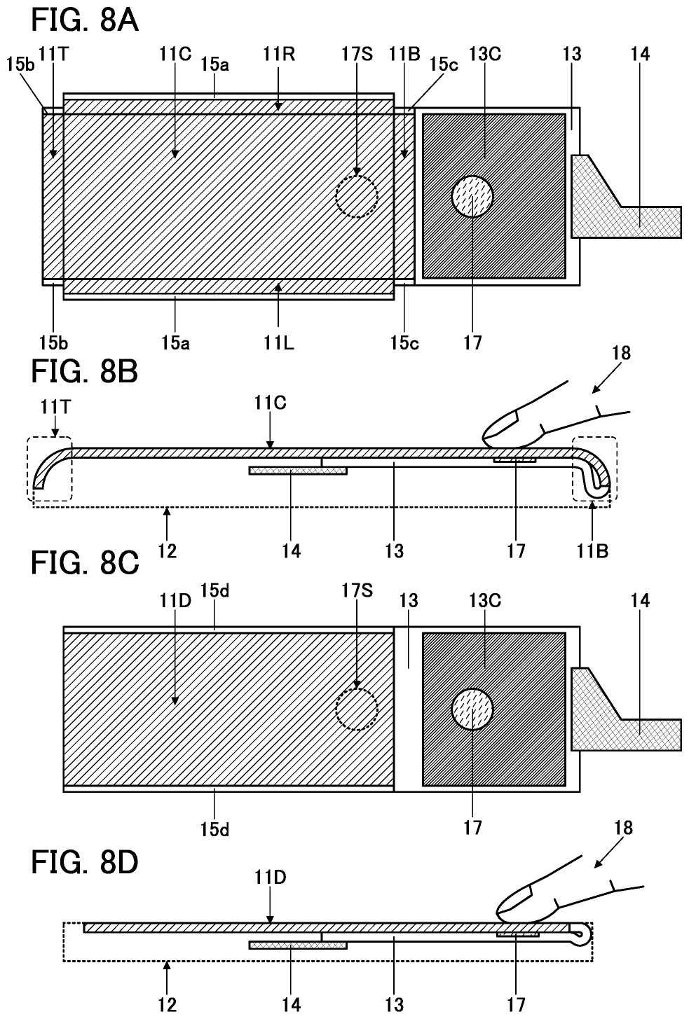

A display module illustrated in FIG. 8A includes a sensor 17. As illustrated in FIG. 8B, the display module is mounted inside the housing 12 so that the sensor 17 is fixed to the back surface of the display portion 11C. In FIG. 8A, a region 17S where the sensor 17 is positioned when the housing 12 is mounted is denoted by a dashed line. In the non-display portion 13, a portion where the sensor 17 is provided can be referred to as a sensor portion.

A pressure-sensitive sensor (a pressure sensor) can be used as the sensor 17. When a portion overlapping with the sensor 17 of the screen is pushed with a finger 18 as illustrated in FIG. 8B, the intensity of the portion is detected. At this time, processing can be executed according to the strength of the pushing.

A sensor module that is formed by a different process from the display module 11 can be used as the sensor 17 and mounted on the non-display portion 13. Alternatively, a sensor element may be incorporated in the display module 11. The latter case is preferable because the number of components can be reduced.

As the pressure-sensitive sensor, a strain gauge pressure sensor, a pressure sensor utilizing a piezoelectric effect, a mechanical pressure sensor, a capacitive pressure sensor, a resistive pressure sensor, or the like can be used. In particular, a capacitive pressure sensor and a resistive pressure sensor are easy to incorporate in the display module 11 because they have high affinity for a semiconductor process.

Alternatively, an optical sensor for obtaining biological information, such as a fingerprint sensor or a vein sensor, can be used as the sensor 17. For example, an imaging device with photoelectric conversion elements arranged in a matrix form can be used as the sensor 17. Furthermore, a light source for irradiating a subject with visible light, ultraviolet light, or infrared light may be included.

Alternatively, a camera (an image sensor) may be used as the sensor 17. In that case, imaging is performed by utilizing external light passing through the display portion 11C and entering the sensor 17; thus, for example, a shortage of the amount of light might be caused or noise due to diffraction by the periodicity of pixels might be generated. Therefore, for optimization, it is preferable to perform processing on the captured image. For example, image processing utilizing a learning model is preferably used. Further alternatively, as the sensor 17, a distance image sensor using LIDAR (light detection and ranging), a distance image sensor using a light flying time (TOF) method, or the like can be used. In the TOF method, an object is irradiated with infrared light for a certain period, and reflected light is obtained by an optical sensor. Utilizing a difference between light irradiation start time and arrival time of reflected light at an optical sensor, distance information can be calculated from an irradiation period, a detection signal, and light speed.

FIGS. 8C and 8D illustrate an example not including the display portions 11R, 11L, 11T, and 11B. The display module illustrated in FIGS. 8C and 8D includes a display portion 11D.

As illustrated in FIG. 8C, a pair of circuit portions 15d is provided adjacent to a pair of end portions along the long side of the display portion 11D. The circuit portion 15d functions as a scan line driver circuit.

Since the display portion 11B is not provided, the display portion 11D and the non-display portion 13 are provided adjacent to each other.

### Structure Example 5

In the case where a scan line driver circuit or a signal line driver circuit is provided in a non-display portion of a display module, the driver circuit generates heat in some cases. In particular, a signal line driver circuit requires high-speed operation compared with a scan line driver circuit, and thus the influence of heat generation on a signal line driver circuit is relatively large. Therefore, a radiator plate is preferably provided in a non-display portion of a display module.

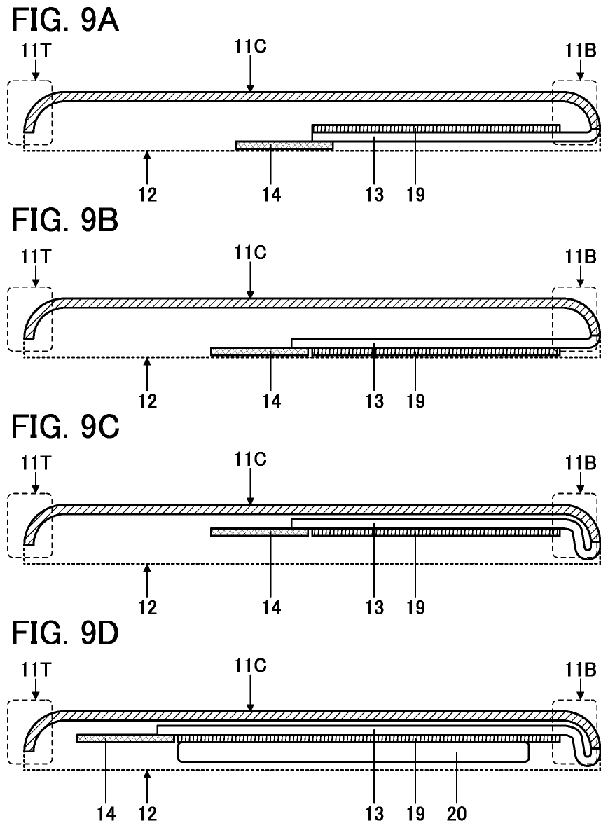

FIG. 9A illustrates an example in which a radiator plate 19 is provided in the non-display portion 13. As the radiator plate 19, a conductive film or plate containing a metal or an alloy can be used. For example, a film of stainless steel, aluminum, copper, or the like is preferably used.

The radiator plate 19 and the non-display portion 13 are preferably bonded to each other with a thermally conductive adhesive agent or adhesive tape (adhesive material). As the thermally conductive adhesive tape, a material formed by dispersing particles having high thermal conductivity into a base material formed of an organic resin can be used. For the particles with high thermal conductivity, a metal, an alloy, or ceramic can be used.

In FIG. 9A, the radiator plate 19 is provided on a surface of the non-display portion 13 on the display portion 11C side. In contrast, in FIG. 9B, the radiator plate 19 is provided on a surface on the opposite side. Note that the radiator plate 19 may be provided on both the surfaces so that the non-display portion 13 is sandwiched between the surfaces.

FIG. 9C illustrates an example in which the non-display portion 13 is placed to be close to the back surface of the display portion 11C. In that case, it is preferable that the radiator plate 19 be placed on a side opposite to the display portion 11C and a space be provided between the display portion 11C and the non-display portion 13. Such a structure can inhibit heat of the non-display portion 13 from being conducted to the display portion 11C.

FIG. 9D illustrates an example including a battery 20. In that case, it is preferable to fix the radiator plate 19 and the exterior of the battery 20 with a thermally conductive adhesive material so that heat of the radiator plate 19 is conducted to the battery 20. In general, repeating charging and discharging of a secondary battery typified by a lithium ion battery in a low temperature condition (e.g., at 5° C. or lower) promotes deterioration of the secondary battery; therefore, the heat of the radiator plate 19 is preferably used so that the temperature of the battery 20 is within a range higher than or equal to 10° C. and lower than 40° C. during the use of the electronic device 10.

At least part of any of the structure examples, the drawings corresponding thereto, and the like described in this embodiment can be implemented in combination with any of the other structure examples, the other drawings corresponding thereto, and the like described in this specification as appropriate.

### Embodiment 2

In this embodiment, structure examples of a display panel and a driver circuit that can be used for the display module described as the example in Embodiment 1 will be described.

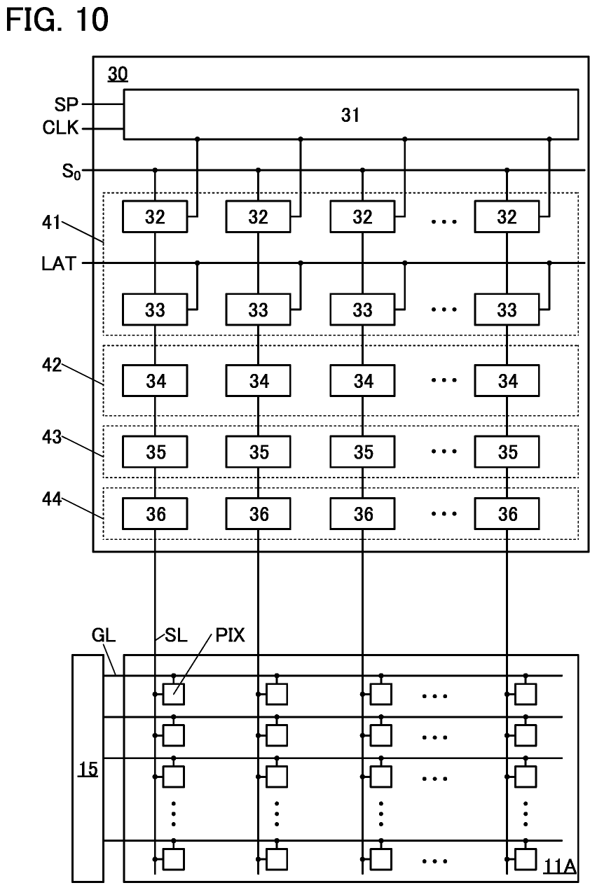

FIG. 10 shows a block diagram of a display panel. The display portion 11A, a driver circuit 30, and a driver circuit 15 are shown in FIG. 10.

The display portion 11A includes a plurality of pixels PIX arranged in a matrix form. The display portion 11A includes a plurality of source lines SL connected to the driver circuit 30 and a plurality of gate lines GL connected to the driver circuit 15. The driver circuit 30 can be used as a signal line driver circuit that can be provided in the circuit portion 13C, the region 16S_1, the region 16S_2, or the like, for example.

The driver circuit 30 includes a shift register circuit 31, a latch circuit portion 41, a level shifter circuit portion 42, a D/A converter portion 43, an analog buffer circuit portion 44, and the like.

The latch circuit portion 41 includes a plurality of latch circuits 32 and a plurality of latch circuits 33. The level shifter circuit portion 42 includes a plurality of level shifter circuits 34. The D/A converter portion 43 includes a plurality of DAC circuits 35. The analog buffer circuit portion 44 includes a plurality of analog buffer circuits 36.

A clock signal CLK and a start pulse signal SP are input to the shift register circuit 31. The shift register circuit 31 generates a timing signal whose pulse sequentially shifts in accordance with the clock signal CLK and the start pulse signal SP, and outputs the timing signal to each of the latch circuits 32 in the latch circuit portion 41.

A video signal S₀ and a latch signal LAT are input to the latch circuit portion 41.

When timing signals are input to the latch circuits 32, the video signals So are sampled in response to pulses of the timing signals and sequentially written to the latch circuits 32. A period until writing of the video signals So to all of the latch circuits 32 is completed can be referred to as a line period.

When the first line period is completed, the video signals held in the latch circuits 32 are written to the latch circuits 33 all at once and held in accordance with a pulse of the latch signal LAT input to each of the latch circuits 33. To the latch circuits 32 that have finished sending the video signals to the latch circuits 33, the next video signals are sequentially written again in accordance with timing signals from the shift register circuit 31. In this second line period, the video signals that have been written to and held in the latch circuits 33 are output to the level shifter circuits 34 in the level shifter circuit portion 42.

When the video signals are input to the level shifter circuits 34, the voltage amplitudes of the signals are amplified by the level shifter circuits 34, and then sent to the DAC circuits 35 in the D/A converter portion 43. The video signals input to the DAC circuit 35 are converted into an analog signal and output to the analog buffer circuit portion 44. The video signals input to the analog buffer circuit portion 44 are output to the source lines SL through the analog buffer circuits 36.

The driver circuit 15 selects the gate lines GL sequentially. The video signals input from the driver circuit 30 to the display portion 11A through the source lines SL are input to the pixels PIX connected to the gate line GL selected by the driver circuit 15.

Note that another circuit that can output a signal whose pulse sequentially shifts may be used instead of the shift register circuit 31.

Transistors provided in the driver circuit 30 and the driver circuit 15 are required to have high switching performance. In particular, the shift register circuit 31 included in the driver circuit 30 needs to have a high switching speed. The use of the vertical transistors of one embodiment of the present invention enables high-speed operation, making it possible to display an image at a higher frame frequency.

### Variation Examples

The driver circuit 30 shown in FIG. 10 has a structure in which a digital signal is converted into an analog signal to be output to the display portion 11A; the use of an analog signal as an input signal further simplifies the structure of the driver circuit 30.

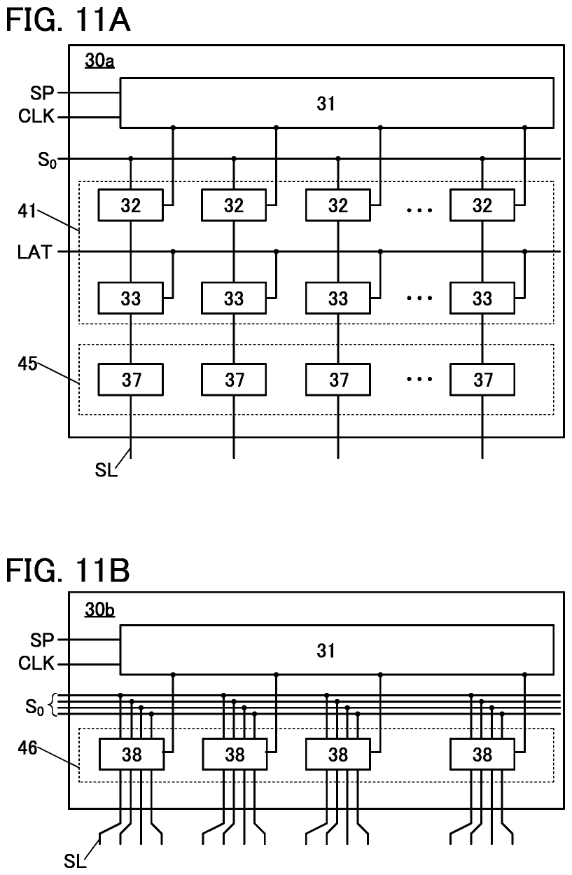

A driver circuit 30a shown in FIG. 11A includes the shift register circuit 31, the latch circuit portion 41, and a source follower circuit portion 45. The source follower circuit portion 45 includes a plurality of source follower circuits 37.

In the latch circuits 32, analog video signals So are sampled as analog data in response to timing signals from the shift register circuit 31. The latch circuits 32 output video signals held in the latch circuits 33 all at once in accordance with the latch signal LAT.

The video signals held in the latch circuits 33 are output to one of the source lines SL through the source follower circuit 37. Note that the aforementioned analog buffer circuit may be used instead of the source follower circuit 37.

A driver circuit 30b shown in FIG. 11B includes the shift register circuit 31 and a demultiplexer circuit 46.

The demultiplexer circuit 46 includes a plurality of sampling circuits 38. Each sampling circuit 38 receives a plurality of analog video signals So from a plurality of wirings and outputs video signals to a plurality of source lines SL at a time in response to a timing signal input from the shift register circuit 31. The shift register circuit 31 outputs timing signals so as to sequentially select a plurality of sampling circuits 38.

For example, in the case where 2160 source lines SL are connected to the display portion 11A and video signals S₀ are supplied from 54 wirings, 40 sampling circuits 38 are provided in the demultiplexer circuit 46, so that one line period can be divided into 40 periods and video signals can be output to 54 source lines SL at a time in each period.

At least part of any of the structure examples, the drawings corresponding thereto, and the like described in this embodiment can be implemented in combination with any of the other structure examples, the other drawings corresponding thereto, and the like as appropriate.

### Embodiment 3

In this embodiment, a structure example of a semiconductor device that can be used in a display module of one embodiment of the present invention will be described. A structure example of a transistor is described below as an example of the semiconductor device of one embodiment of the present invention.

The transistor of one embodiment of the present invention includes a semiconductor layer, a gate insulating layer, a gate electrode, a first electrode, and a second electrode. The first electrode functions as one of a source electrode and a drain electrode, and the second electrode functions as the other of the source electrode and the drain electrode.

The second electrode is provided above the first electrode. Between the first electrode and the second electrode, an insulating layer functioning as a spacer is provided. An opening reaching the first electrode is provided in the spacer, and the semiconductor layer is provided in contact with the first electrode, the second electrode, and a side wall (also referred to as a side surface) of the insulating layer in the opening. The gate insulating layer and the gate electrode are provided to cover the semiconductor layer.

Here, the first electrode and the second electrode may be provided independently from the semiconductor layer or part of the semiconductor layer may function as the first electrode or the second electrode.

In the transistor having the above structure, the source electrode and the drain electrode are positioned at different heights, so that current flows in the semiconductor layer in the height direction. In other words, the channel length direction can be regarded as having a component of the height direction (the vertical direction); accordingly, the transistor of one embodiment of the present invention can be referred to as a vertical field-effect transistor (VFET), a vertical transistor, a vertical-channel transistor, and the like.

In the above transistor, the source electrode, the semiconductor layer, and the drain electrode can be provided to overlap with each other. Thus, the area occupied by the above transistor can be significantly smaller than that of a so-called planar transistor (can also be referred to as a lateral transistor, (lateral FET, LFET)) in which a semiconductor layer is provided over a flat surface

Moreover, the channel length of the above transistor can be precisely adjusted by the thickness of the insulating layer; therefore, a variation in the channel length can be extremely smaller than that of a planar transistor. Furthermore, by reducing the thickness of an insulating layer, a transistor with an extremely short channel length can be manufactured. For example, it is possible to manufacture a transistor with a channel length of 2 μm or shorter, 1 μm or shorter, 500 nm or shorter, 300 nm or shorter, 200 nm or shorter, 100 nm or shorter, 50 nm or shorter, 30 nm or shorter, or 20 nm or shorter and 5 nm or longer, 7 nm or longer, or 10 nm or longer. Therefore, it is possible to achieve a transistor with an extremely short channel length that could not be achieved with a conventional light-exposure apparatus for mass production of flat panel displays (the minimum line width: approximately 2 μm or approximately 1.5 μm, for example). Moreover, it is also possible to achieve a transistor with a channel length shorter than 10 nm without using an extremely expensive light-exposure apparatus used in the latest LSI technology.

A film of a metal oxide having semiconductor characteristics (also referred to as an oxide semiconductor) is particularly preferable for the semiconductor layer because both high performance and high productivity can be achieved. In particular, an oxide semiconductor film having crystallinity is further preferable because high reliability can be achieved.

More specific examples are described below with reference to drawings.

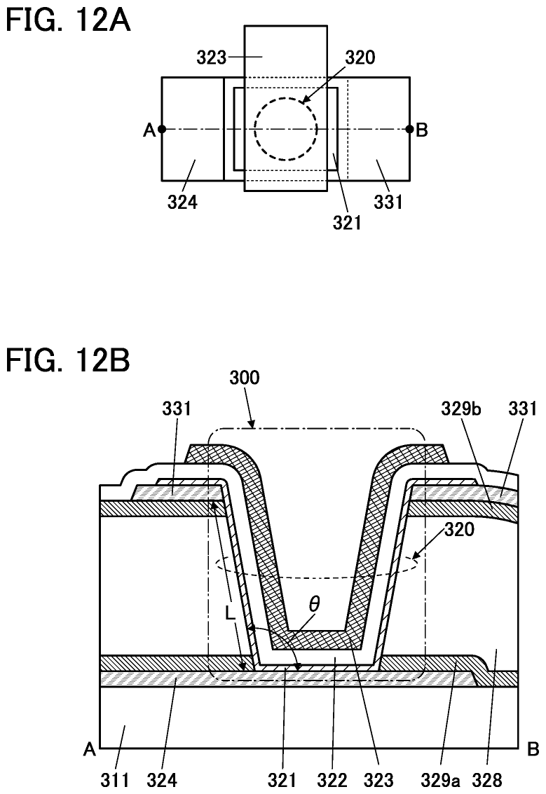

FIG. 12A is a top view of a transistor 300, and FIG. 12B is a cross-sectional view taken along line A-B in FIG. 12A. Note that some components (e.g., insulating layers) are omitted in FIG. 12A.

The transistor 300 is provided over a substrate 311 and includes a semiconductor layer 321, an insulating layer 322, a conductive layer 323, a conductive layer 324, and a conductive layer 331.

As illustrated in FIG. 12B, the conductive layer 324 is provided over the substrate 311 and an insulating layer 329a, an insulating layer 328, and an insulating layer 329b are provided in this order to cover the conductive layer 324. Moreover, the conductive layer 331 is provided over the insulating layer 329b. An opening 320 reaching the conductive layer 324 is provided in the conductive layer 331, the insulating layer 329b, the insulating layer 328, and the insulating layer 329a. For example, it can also be said that side walls (side surfaces) of the conductive layer 331, the insulating layer 329b, the insulating layer 328, and the insulating layer 329a in the opening 320 overlap with the conductive layer 324.

The semiconductor layer 321 is in contact with the top surface of the conductive layer 324 positioned at the bottom of the opening 320; the side surfaces of the insulating layers 329a, 328, and 329b; the side surface of the conductive layer 331 in the opening 320; and the top surface of the conductive layer 331. A portion of the semiconductor layer 321 that is in contact with the conductive layer 331 functions as one of a source region and a drain region, a portion of the semiconductor layer 321 that is in contact with the conductive layer 324 functions as the other of the source region and the drain region, and a region between these portions (in particular, a region in contact with the insulating layer 328) functions as a region where a channel is formed (a channel formation region). It is preferable that in the semiconductor layer 321, a region in contact with the insulating layer 329a and a region in contact with the insulating layer 329b have a higher carrier concentration and a lower resistance than the channel formation region.

The insulating layer 322 functioning as a gate insulating layer is provided to cover the insulating layer 329b, the conductive layer 331, and the semiconductor layer 321. In addition, the conductive layer 323 functioning as a gate electrode is provided to cover the insulating layer 322.

The semiconductor layer 321 includes the portion that is in contact with the side surface of the insulating layer 328 and functions as a channel formation region. In the opening 320, the insulating layer 322 includes a portion facing the side surface of the insulating layer 328 with the semiconductor layer 321 therebetween. The conductive layer 323 includes a portion facing the side surface of the insulating layer 328 with the semiconductor layer 321 and the insulating layer 322 therebetween. An interface between the semiconductor layer 321 and the insulating layer 322 and an interface between the insulating layer 322 and the conductive layer 323 each include a portion parallel to the side surface of the insulating layer 328.

The semiconductor layer 321 preferably includes a metal oxide (an oxide semiconductor).

Examples of a metal oxide that can be used for the semiconductor layer 321 include an In oxide, a Ga oxide, and a Zn oxide. The metal oxide preferably contains at least In or Zn. The metal oxide preferably contains two or three elements selected from In, an element M, and Zn. The element M is a metal element or metalloid element that has a high bonding energy with oxygen, such as a metal element or metalloid element whose bonding energy with oxygen is higher than that of In. Specific examples of the element M include Al, Ga, Sn, Y, Ti, V, Cr, Mn, Fe, Co, Ni, Zr, Mo, Hf, Ta, W, La, Ce, Nd, Mg, Ca, Sr, Ba, B, Si, Ge, and Sb. The element M contained in the metal oxide is preferably one or more kinds selected from the above elements. Specifically, the element M is preferably one or more kinds selected from Al, Ga, Y, and Sn, further preferably Ga. Hereinafter, a metal oxide containing In, M, and Zn is referred to as In-M-Zn oxide in some cases. In this specification and the like, a metal element and a metalloid element may be collectively referred to as a “metal element” and a “metal element” in this specification and the like may refer to a metalloid element.

When the metal oxide is In-M-Zn oxide, the proportion of the number of In atoms is preferably greater than or equal to that of the number of M atoms in the In-M-Zn oxide. Examples of the atomic ratio of the metal elements of such In-M-Zn oxide include In:M:Zn=1:1:1, In:M:Zn=1:1:1.2, In:M:Zn=2:1:3, In:M:Zn=3:1:2, In:M:Zn=4:2:3, In:M:Zn=4:2:4.1, In:M:Zn=5:1:3, In:M:Zn=5:1:6, In:M:Zn=5:1:7, In:M:Zn=5:1:8, In:M:Zn=6:1:6, and In:M:Zn=5:2:5 and a composition in the vicinity of any of the above atomic ratios. Note that the vicinity of the atomic ratio includes ±30% of an intended atomic ratio. By increasing the proportion of the number of In atoms in the metal oxide, the on-state current, field-effect mobility, or the like of the transistor can be improved.

The proportion of the number of In atoms may be less than that of the number of M atoms in the In-M-Zn oxide. Examples of the atomic ratio of the metal elements of such In-M-Zn oxide include In:M:Zn=1:3:2, In:M:Zn=1:3:3, and In:M:Zn=1:3:4 and a composition in the vicinity of any of the above atomic ratios. By increasing the proportion of the number of M atoms in the metal oxide, generation of oxygen vacancies can be suppressed.

For the semiconductor layer 321, for example, In—Zn oxide, In—Ga oxide, In—Sn oxide, In—Ti oxide, In—Ga—Al oxide, In—Ga—Sn oxide, In—Ga—Zn oxide, In—Sn—Zn oxide, In—Al—Zn oxide, In—Ti—Zn oxide, In—Ga—Sn—Zn oxide, or In—Ga—Al—Zn oxide can be used. Alternatively, Ga—Zn oxide may be used.

Note that the metal oxide may contain, instead of or in addition to In, one or more kinds selected from metal elements belonging to a period of a higher number in the periodic table. As the overlap between orbits of metal elements is larger, the metal oxide tends to have higher carrier conductivity. Thus, a transistor containing a metal element belonging to a period of a higher number in the periodic table can have high field-effect mobility in some cases. Examples of the metal element belonging to a period of a higher number in the periodic table include metal elements belonging to Period 5 and metal elements belonging to Period 6. Specific examples of the metal element include Y, Zr, Ag, Cd, Sn, Sb, Ba, Pb, Bi, La, Ce, Pr, Nd, Pm, Sm, and Eu. Note that La, Ce, Pr, Nd, Pm, Sm, and Eu are referred to as light rare earth elements.

The metal oxide may contain one or more kinds selected from nonmetallic elements. A transistor including the metal oxide containing a nonmetallic element can have high field-effect mobility in some cases. Examples of the nonmetallic element include carbon, nitrogen, phosphorus, sulfur, selenium, fluorine, chlorine, bromine, and hydrogen.

A sputtering method or an atomic layer deposition (ALD) method can be suitably used for forming the metal oxide. Note that in the case where the metal oxide is formed by a sputtering method, the atomic ratio of the deposited metal oxide may be different from the atomic ratio of a target. In particular, the zinc content of the deposited metal oxide may be reduced to approximately 50% of that of the target.

In this specification and the like, the content of a certain metal element in a metal oxide refers to the proportion of the number of atoms of the metal element to the total number of metal element atoms contained in the metal oxide. In the case where a metal oxide contains a metal element X, a metal element Y, and a metal element Z whose atomic numbers are respectively represented by A_{X}, A_{Y}, and A_{Z}, the content of the metal element X can be represented by A_{X}/(A_{X}+A_{Y}+A_{Z}). Moreover, in the case where the atomic ratio of the metal element X to the metal element Y and the metal element Z contained in the metal oxide is represented by B_{X}:B_{Y}:B_{Z}, the content of the metal element X can be represented by B_{X}/(B_{X}+B_{Y}+B_{Z}).

In the case of using a metal oxide containing In, for example, an increase in the In content enables a transistor to have a high on-state current.

When the semiconductor layer 321 includes a metal oxide not containing Ga or having a low Ga content, a transistor can have high reliability against positive bias application. That is, the transistor can show a small amount of change in the threshold voltage in the positive bias temperature stress (PBTS) test. In the case of using a metal oxide containing Ga, the Ga content is preferably lower than the In content. Accordingly, the transistor can have high mobility and high reliability.

Meanwhile, a transistor having a high Ga content can have high reliability against light. That is, the transistor can show a small amount of change in the threshold voltage of the transistor in the negative bias temperature illumination stress (NBTIS) test. Specifically, a metal oxide in which the proportion of the number of Ga atoms is greater than or equal to that of the number of In atoms has a wider band gap and can reduce the amount of change in the threshold voltage of the transistor in the NBTIS test.

Furthermore, a metal oxide having a high zinc content has high crystallinity, whereby diffusion of impurities in the metal oxide can be inhibited. Consequently, a change in electrical characteristics of the transistor is suppressed and the transistor can have high reliability.

The semiconductor layer 321 may have a stacked-layer structure including two or more metal oxide layers. The two or more metal oxide layers included in the semiconductor layer 321 may have the same composition or substantially the same compositions. Employing a stacked-layer structure of metal oxide layers having the same composition can reduce the manufacturing cost because the metal oxide layers can be formed using the same sputtering target. Note that a stacked-layer structure including two or more oxide semiconductor layers having different compositions may be employed.

It is preferable to use a metal oxide layer having crystallinity as the semiconductor layer 321. For example, a metal oxide layer having a c-axis aligned crystal (CAAC) structure, a polycrystalline structure, a nano-crystal (nc) structure, or the like can be used. By using a metal oxide layer having crystallinity as the semiconductor layer 321, the density of defect states in the semiconductor layer 321 can be reduced, which enables the semiconductor device to have high reliability.

As the crystallinity of the metal oxide layer used as the semiconductor layer 321 becomes higher, the density of defect states in the semiconductor layer 321 can be reduced. In contrast, the use of a metal oxide layer having low crystallinity enables a transistor to flow a large amount of current.

A transistor including an oxide semiconductor (hereinafter referred to as an OS transistor) has much higher field-effect mobility than a transistor including amorphous silicon. In addition, the OS transistor has an extremely low leakage current between a source and a drain in an off state (the leakage current is also referred to as an off-state current), and charge accumulated in a capacitor that is connected in series to the transistor can be retained for a long period. Furthermore, the power consumption of the semiconductor device can be reduced with the OS transistor.

Since an OS transistor has a higher withstand voltage between the source and the drain than a transistor including silicon (hereinafter referred to as a Si transistor), a high voltage can be applied between the source and the drain of the OS transistor. Furthermore, when transistors operate in a saturation region, a change in a source-drain current relative to a change in a gate-source voltage can be smaller in an OS transistor than in a Si transistor.

A change in electrical characteristics of an OS transistor due to irradiation with radiation is small, i.e., an OS transistor has high resistance to radiation; thus, an OS transistor can be suitably used even in an environment where radiation can enter. It can also be said that an OS transistor has high reliability against radiation. For example, an OS transistor can be suitably used for a pixel circuit of an X-ray flat panel detector. Moreover, an OS transistor can be suitably used for a semiconductor device used in space. Examples of radiation include electromagnetic radiation (e.g., X-rays and gamma rays) and particle radiation (e.g., alpha rays, beta rays, a proton beam, and a neutron beam).

Note that a semiconductor material that can be used for the semiconductor layer 321 is not limited to an oxide semiconductor. For example, a single-element semiconductor or a compound semiconductor can be used. Examples of the single-element semiconductor include silicon (such as single crystal silicon, polycrystalline silicon, microcrystalline silicon, and amorphous silicon) and germanium. Examples of the compound semiconductor include gallium arsenide and silicon germanium. Examples of the compound semiconductor include an organic semiconductor, a nitride semiconductor, and an oxide semiconductor. These semiconductor materials may contain impurities as dopants.

Alternatively, the semiconductor layer 321 may include a layered material functioning as a semiconductor. The layered material generally refers to a group of materials having a layered crystal structure. In the layered crystal structure, layers formed by covalent bonding or ionic bonding are stacked with bonding such as the van der Waals binding, which is weaker than covalent bonding or ionic bonding. The layered material has high electrical conductivity in a monolayer, that is, high two-dimensional electrical conductivity. When a material that functions as a semiconductor and has high two-dimensional electrical conductivity is used for a channel formation region, the transistor can have a high on-state current.

Examples of the layered material include graphene, silicene, and chalcogenide. Chalcogenide is a compound containing chalcogen (an element belonging to Group 16). Examples of chalcogenide include transition metal chalcogenide and chalcogenide of Group 13 elements. Specific examples of the transition metal chalcogenide which can be used for a semiconductor layer of a transistor include molybdenum sulfide (typically MoS₂), molybdenum selenide (typically MoSe₂), molybdenum telluride (typically MoTe₂), tungsten sulfide (typically WS₂), tungsten selenide (typically WSe₂), tungsten telluride (typically WTe₂), hafnium sulfide (typically HfS₂), hafnium selenide (typically HfSe₂), zirconium sulfide (typically ZrS₂), and zirconium selenide (typically ZrSe₂).

There is no particular limitation on the crystallinity of a semiconductor material used for the semiconductor layer 321, and any of an amorphous semiconductor, a single crystal semiconductor, and a semiconductor having other crystallinity than single crystal (a polycrystalline semiconductor, a microcrystalline semiconductor, or a semiconductor partly including crystal regions) may be used. It is preferable to use a semiconductor having crystallinity, in which case deterioration of the transistor characteristics can be suppressed.

The top surface of the conductive layer 324 and the top surface of the conductive layer 331 are each in contact with the semiconductor layer 321. Here, when the semiconductor layer 321 is formed using an oxide semiconductor and the conductive layer 324 or the conductive layer 331 is formed using, for example, a metal that is likely to be oxidized such as aluminum, an insulating oxide (e.g., aluminum oxide) is formed between the conductive layer 324 or the conductive layer 331 and the semiconductor layer 321, which might inhibit continuity between the conductive layer 324 or the conductive layer 331 and the semiconductor layer 321. Therefore, the conductive layer 324 and the conductive layer 331 are preferably formed using a conductive material that is less likely to be oxidized, a conductive material that maintains low electric resistance even when oxidized, or an oxide conductive material.

A light-transmitting oxide conductive material can be used for the conductive layer 324 and the conductive layer 331. For example, a conductive oxide such as indium oxide, zinc oxide, In—Sn oxide, In—Zn oxide, In—W oxide, In—W—Zn oxide, In—Ti oxide, In—Ti—Sn oxide, In—Sn oxide containing silicon, or zinc oxide to which gallium is added can be used. A conductive oxide containing indium is particularly preferable because of its high conductivity.

Since the conductive layer 324 does not necessarily have a light-transmitting property, a conductive material that absorbs or reflects part of visible light may be used for the conductive layer 324. For example, tantalum nitride, titanium nitride, a nitride containing titanium and aluminum, a nitride containing tantalum and aluminum, ruthenium oxide, ruthenium nitride, an oxide containing strontium and ruthenium, or an oxide containing lanthanum and nickel can be used. Alternatively, titanium, ruthenium, tungsten, or the like can be used. These materials are preferable because they are conductive materials that are less likely to be oxidized or materials that maintain the conductivity even when being oxidized.

The insulating layer 322 functions as a gate insulating layer. In the case where the semiconductor layer 321 is formed using an oxide semiconductor, an oxide insulating film is preferably used for at least portions of the insulating layer 322 that are in contact with the semiconductor layer 321. For example, one or more of silicon oxide, silicon oxynitride, aluminum oxide, aluminum oxynitride, hafnium oxide, hafnium oxynitride, gallium oxide, gallium oxynitride, yttrium oxide, yttrium oxynitride, and Ga—Zn oxide can be used. In addition, as the insulating layer 322, a nitride insulating film of silicon nitride, silicon nitride oxide, aluminum nitride, or aluminum nitride oxide can also be used. The insulating layer 322 may have a stacked-layer structure, e.g., a stacked-layer structure including at least one oxide insulating film and at least one nitride insulating film.

Note that in this specification and the like, oxynitride refers to a material that contains more oxygen than nitrogen. Nitride oxide refers to a material that contains more nitrogen than oxygen.

The conductive layer 323 functions as a gate electrode and can be formed using a variety of conductive materials. The conductive layer 323 can be formed using one or more of chromium, copper, aluminum, gold, silver, zinc, molybdenum, tantalum, titanium, tungsten, manganese, nickel, iron, cobalt, molybdenum, and niobium or an alloy including one or more of these metal elements as its component, for example. For the conductive layer 323, the nitride and the oxide that can be used for the conductive layer 324 and the conductive layer 331 may be used.

The insulating layer 328 includes portions in contact with the semiconductor layer 321. In the case where the semiconductor layer 321 is formed using an oxide semiconductor, an oxide is preferably used for at least the portions of the insulating layer 328 that are in contact with the semiconductor layer 321 in order to improve the properties of the interface between the insulating layer 328 and the semiconductor layer 321. For example, silicon oxide or silicon oxynitride can be suitably used.

As the insulating layer 328, it is further preferable to use a film from which oxygen is released by heating. Accordingly, oxygen can be supplied to the semiconductor layer 321 owing to heat applied during the manufacturing process of the transistor 300, the amount of oxygen vacancy in the semiconductor layer 321 can be reduced, and reliability can be improved. Examples of a method for supplying oxygen to the insulating layer 328 include heat treatment in an oxygen atmosphere and plasma treatment in an oxygen atmosphere. Alternatively, an oxide film may be deposited over the top surface of the insulating layer 328 by a sputtering method in an oxygen atmosphere to supply oxygen. After that, the oxide film may be removed.

The insulating layer 328 is preferably formed by a deposition method such as a sputtering method or a plasma CVD method. In particular, by a sputtering method using a deposition gas not containing a hydrogen gas, a film having an extremely low hydrogen content can be formed. Therefore, supply of hydrogen to the semiconductor layer 321 is inhibited and the electrical characteristics of the transistor 300 can be stabilized.

As the insulating layers 329a and 329b, films in which oxygen is less likely to be diffused are preferably used. Accordingly, it is possible to prevent oxygen contained in the insulating layer 328 from being diffused toward the substrate 311 side and the insulating layer 322 side through the insulating layer 329a and the insulating layer 329b, respectively, due to heating. In other words, when the insulating layers 329a and 329b in which oxygen is less likely to be diffused are respectively provided above and below the insulating layer 328 so that the insulating layer 328 is sandwiched therebetween, oxygen can be enclosed in the insulating layer 328. Accordingly, oxygen can be effectively supplied to the semiconductor layer 321.

For the insulating layers 329a and 329b, for example, one or more of silicon nitride, silicon nitride oxide, silicon oxynitride, aluminum oxide, aluminum oxynitride, aluminum nitride, hafnium oxide, and hafnium aluminate can be used. Silicon nitride and silicon nitride oxide are particularly suitable for the insulating layers 329a and 329b because they release fewer impurities (e.g., water and hydrogen) and are less likely to transmit oxygen and hydrogen.

In this specification and the like, the channel length L of the transistor 300 refers to the shortest distance between a portion of the semiconductor layer 321 in contact with the conductive layer 324 and a portion of the semiconductor layer 321 in contact with the conductive layer 331 as illustrated in FIG. 12B. As the slopes of the side surfaces of the insulating layers 329a, 328, and 329b in the opening 320 are close to perpendicular to the substrate surface, the channel length L is shorter.

The channel width W of the transistor 300 is equal to the perimeter of the opening 320. When the top surface shape of the opening 320 is a circular shape as illustrated in FIG. 12A and the diameter is R, the channel width W of the transistor 300 is equal to the circumference of the opening 320, i.e., the channel width W is π×R. When the top surface shape of the opening 320 is a circular shape, the channel width W of the transistor can be the smallest.

Note that in this specification and the like, a top surface shape of a component means the outline of the component in the plan view. A plan view means that the component is observed from a normal direction of a surface where the component is formed or from a normal direction of a surface of a support (e.g., a substrate) where the component is formed.

Actually, the diameter of the opening 320 changes with depth in many cases. In this case, the average value of the diameters at three points corresponding to the highest, lowest, halfway points at the insulating layer 328 in a cross-sectional view can be used as the diameter of the opening 320. Without being limited to the above, the diameter of the opening 320 may be any of the diameters at the three points corresponding to the highest, lowest, halfway points at the insulating layer 328.

Note that although the opening 320 has a circular shape in the above, there is no limitation and a variety of shapes can be employed. Besides the circular shape, for example, an elliptical shape or a quadrangular shape with rounded corners can be employed. Alternatively, a regular polygonal shape such as a regular triangular shape, a square shape, or a regular pentagonal shape or a polygonal shape other than the regular polygonal shape may be employed. By employing a depressed polygonal shape in which at least one interior angle is greater than 180°, such as a star polygonal shape, the channel width can be increased

FIG. 12B illustrates an example where in the opening 320, the side surfaces of the insulating layers 328, 329a, and 329b are inclined upward, i.e., the side surfaces have so-called tapered shapes. Here, when the angle between the side surface of the insulating layer 328 in the opening 320 and the top surface of the insulating layer 324 at the bottom of the opening 320 is denoted by an angle θ, it is preferable that the angle θ have a portion greater than or equal to 90° and less than or equal to 135°, preferably less than or equal to 125°, further preferably less than or equal to 120°, still further preferably less than or equal to 110°. As the angle θ is closer to 90°, i.e., the slope of the side surface of the insulating layer 328 is close to perpendicular to the substrate surface, the area occupied by the transistor 300 can be reduced. Note that in the case where a stack of the semiconductor layer 321, the insulating layer 322, and the conductive layer 323 can cover the side surface of the insulating layer 328, the angle θ may be less than 90°.

The semiconductor layer 321 is deposited along the side surfaces of the insulating layers 329a, 328, and 329b in the opening. At this time, if film deposition is performed by a deposition method such as a sputtering method or a plasma CVD method, a film deposited on a surface inclined with respect to the substrate surface or a surface perpendicular to the substrate surface tends to be thinner than a film deposited on a surface horizontal to the substrate surface. Thus, when the semiconductor layer 321 is formed by a sputtering method, portions in contact with the insulating layer 328 may be thinner than portions in contact with the top surface of the conductive layer 324 and portions in contact with the top surface of the conductive layer 331.

In a manner similar to the above, the insulating layer 322 and the conductive layer 323 may be deposited so that portions deposited along the side surface of the insulating layer 328 or the like in the opening are thinner than portions formed over the top surfaces of the conductive layer 324 and the conductive layer 331.

Meanwhile, a film deposited by an ALD method or the like can have a uniform thickness regardless of the tilt angle of a formation surface, so that thickness variation hardly occurs in the semiconductor layer 321, the insulating layer 322, the conductive layer 323, and the like.

The transistor described in this embodiment can achieve high switching characteristics. Therefore, when the transistor is used in the display module of one embodiment of the present invention, an electronic device capable of displaying a high-quality image with high resolution and high frame rate can be obtained.

At least part of any of the structure examples, the drawings corresponding thereto, and the like described in this embodiment can be implemented in combination with any of the other structure examples, the other drawings corresponding thereto, and the like as appropriate.

### Embodiment 4

In this embodiment, a display device that can be used in the display module of one embodiment of the present invention will be described.

The display device in this embodiment can be a high-resolution display device or large-sized display device. Accordingly, the display device in this embodiment can be used for display portions of electronic devices such as a digital camera, a digital video camera, a digital photo frame, a mobile phone, a portable game console, a portable information terminal, and an audio reproducing device, in addition to display portions of electronic devices with a relatively large screen, such as a television device, a desktop or laptop personal computer, a monitor of a computer or the like, digital signage, and a large game machine such as a pachinko machine.

The display device in this embodiment can be a high-resolution display device. Accordingly, the display device in this embodiment can be used for display portions of information terminals (wearable devices) such as watch-type and bracelet-type information terminals and display portions of wearable devices capable of being worn on the head, such as a VR device like a head-mounted display (HMD) and a glasses-type AR device.

The transistor of one embodiment of the present invention can be used for a display device or a module including the display device. Examples of the module including the display device include a module in which a connector such as a flexible printed circuit board (FPC) or a tape carrier package (TCP) is attached to the display device and a module which is mounted with an integrated circuit (IC) by a chip on glass (COG) method, a chip on film (COF) method, or the like.

### [Display Device 100A]

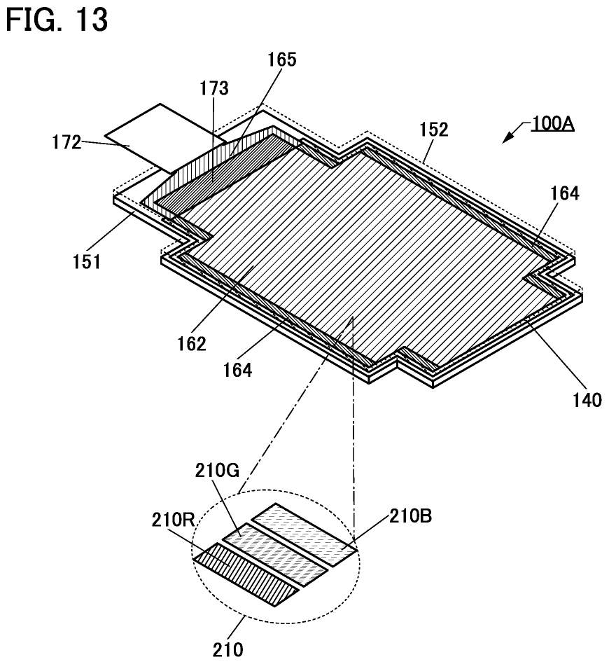

FIG. 13 illustrates a perspective view of a display device 100A.

In the display device 100A, a substrate 152 and a substrate 151 are bonded to each other. In FIG. 13, the substrate 152 is denoted by a dashed line.

The display device 100A includes a display portion 162, a connection portion 140, a circuit portion 164, a wiring 165, a circuit portion 173, and the like. FIG. 13 illustrates an example in which an FPC 172 is mounted on the display device 100A. Thus, the structure illustrated in FIG. 13 can be regarded as a display module including the display device 100A and the FPC.

The connection portion 140 is provided outside the display portion 162. The connection portion 140 can be provided along one or more sides of the display portion 162. The number of connection portions 140 may be one or more. In the example illustrated in FIG. 13, the connection portion 140 is provided to surround the display portion 162. In the connection portion 140, a common electrode of a display element is electrically connected to a conductive layer, and a potential can be supplied to the common electrode.

The circuit portion 164 includes a scan line driver circuit (also referred to as a gate driver), for example. The circuit portion 173 includes a scan line driver circuit (also referred to as a source driver or a data driver).

The wiring 165 has a function of supplying signals and power to the display portion 162 and the circuit portions 164 and 173. The signals and power are input to the wiring 165 from the outside through the FPC 172.

Note that the substrate 151 may be provided with an IC by a COG method, a COF method, or the like. An IC including one or both of a scan line driver circuit and a signal line driver circuit can be used as the IC, for example. Note that the display device 100A and the display module are not provided with an IC in the structure illustrated in FIG. 13. The IC may be mounted on the FPC by a COF method or the like.

The semiconductor device of one embodiment of the present invention can be used in one or more of the display portion 162 and the circuit portions 164 and 173 of the display device 100A, for example. In the case where an IC is mounted, the semiconductor device of one embodiment of the present invention can also be used in the IC.

When the semiconductor device of one embodiment of the present invention is used in a pixel circuit of a display device, an area occupied by the pixel circuit can be reduced and the display device can have high resolution, for example. When the semiconductor device of one embodiment of the present invention is used in a driver circuit (e.g., one or both of a gate line driver circuit and a source line driver circuit) of a display device, an area occupied by the driver circuit can be reduced and the display device can have a narrow bezel, for example. Since the semiconductor device of one embodiment of the present invention has favorable electrical characteristics, a display device can have increased reliability by using the semiconductor device.

The display portion 162 of the display device 100A is a region where an image is to be displayed, and includes a plurality of pixels 210 that are arranged periodically. An enlarged view of one pixel 210 is illustrated in FIG. 13.

There is no particular limitation on the arrangement of pixels in the display device of one embodiment of the present invention, and a variety of arrangements can be employed. Examples of the arrangement of pixels include stripe arrangement, S stripe arrangement, matrix arrangement, delta arrangement, Bayer arrangement, and pentile arrangement.

The pixel 210 illustrated in FIG. 13 includes a subpixel 210R that emits red light, a subpixel 210G that emits green light, and a subpixel 210B that emits blue light.

Any of a variety of elements can be used as the display element, and a liquid crystal element or a light-emitting element can be used, for example. Alternatively, a micro electro mechanical systems (MEMS) shutter element, an optical interference type MEMS element, or a display element using a microcapsule method, an electrophoretic method, an electrowetting method, an Electronic Liquid Powder (registered trademark) method, or the like can be used. Alternatively, a quantum-dot LED (QLED) employing a light source and color conversion technology using quantum dot materials may be used.

Examples of a display device that includes a liquid crystal element include a transmissive liquid crystal display device, a reflective liquid crystal display device, and a transflective liquid crystal display device.

As the light-emitting element, a self-luminous light-emitting element such as a light-emitting diode (LED), an organic LED (OLED), or a semiconductor laser can be used. Examples of the LED include a mini LED and a micro LED.

Examples of a light-emitting substance contained in the light-emitting element include a substance exhibiting fluorescence (a fluorescent material), a substance exhibiting phosphorescence (a phosphorescent material), a substance exhibiting thermally activated delayed fluorescence (a thermally activated delayed fluorescent (TADF) material), and an inorganic compound (e.g., a quantum dot material).

The light-emitting element can emit infrared, red, green, blue, cyan, magenta, yellow, or white light, for example. When the light-emitting element has a microcavity structure, higher color purity can be achieved.

One of a pair of electrodes of the light-emitting element functions as an anode, and the other electrode functions as a cathode. The display device of one embodiment of the present invention can have any of the following structures: a top-emission structure in which light is emitted in a direction opposite to the substrate where the light-emitting element is formed, a bottom-emission structure in which light is emitted toward the substrate where the light-emitting element is formed, and a dual-emission structure in which light is emitted toward both surfaces.

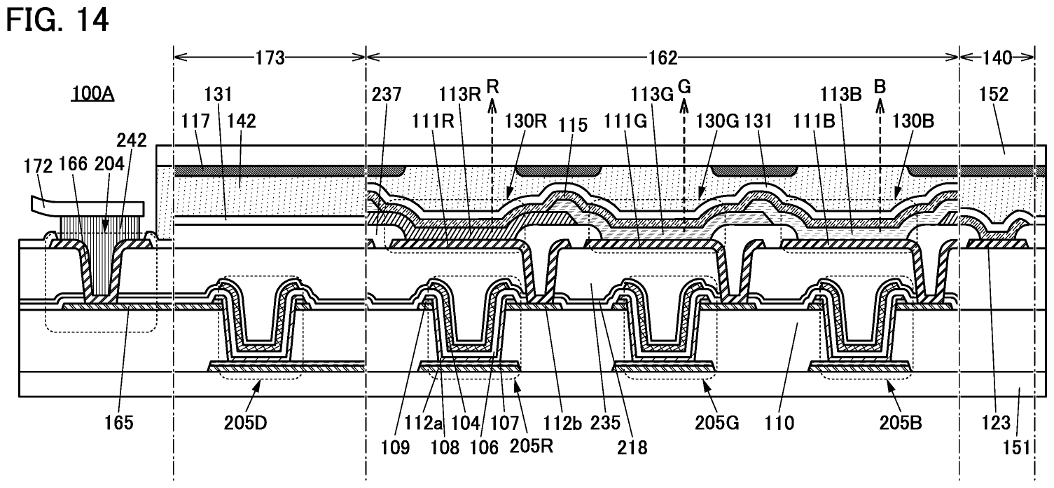

FIG. 14 illustrates an example of cross sections of part of a region including the FPC 172, part of the circuit portion 173, part of the display portion 162, part of the connection portion 140, and part of a region including an end portion of the display device 100A.

The display device 100A illustrated in FIG. 14 includes transistors 205D, 205R, 205G, and 205B, light-emitting elements 130R, 130G, and 130B, and the like between the substrates 151 and 152. The light-emitting elements 130R, 130G, and 130B are a display element of the subpixel 210R emitting red light, a display element of the subpixel 210G emitting green light, and a display element of the subpixel 210B emitting blue light, respectively.

The display device 100A employs an SBS structure. The SBS structure can optimize materials and structures of light-emitting elements and thus can extend freedom of choice of materials and structures, whereby the luminance and the reliability can be easily improved. The display device 100A is a top-emission display device. The aperture ratio of pixels in a top-emission structure can be higher than that of pixels in a bottom-emission structure because a transistor and the like can be provided so as to overlap with a light-emitting region of a light-emitting element in the top-emission structure.

All of the transistors 205D, 205R, 205G, and 205B are formed over the substrate 151. These transistors can be manufactured through the same process.

In this embodiment, an example where the transistor of one embodiment of the present invention, which includes an oxide semiconductor in the semiconductor, is used as each of the transistors 205D, 205R, 205G, and 205B is described. The transistors 205R, 205G, and 205B function as, for example, driving transistors for controlling current flowing through the light-emitting elements. The transistor 205D provided in the circuit portion 173 constitutes part of the driver circuit. Note that a transistor similar to the transistor 205D can be provided in the circuit portion 164.

Specifically, each of the transistors 205D, 205R, 205G, and 205B includes a conductive layer 104 functioning as a gate, an insulating layer 106 functioning as a gate insulating layer, a conductive layer 109 functioning as one of a source electrode and a drain electrode, a conductive layer 107 functioning as the other of the source electrode and the drain electrode, a semiconductor layer 108, an insulating layer 110, and the like. The conductive layers 109 and 107 are in contact with the semiconductor layer 108. In addition, a conductive layer 112a in contact with the conductive layer 107 and a conductive layer 112b in contact with the conductive layer 109 are provided. Each of the conductive layers 112a and 112b contains a conductive material having lower resistance than the conductive layers 107 and 109 and functions as a wiring. Here, a plurality of layers obtained by processing the same film are shown with the same hatching pattern.

As described above, the display device 100A includes the transistor of one embodiment of the present invention in both the display portion 162 and the circuit portion 173. Although not shown here, the transistor of one embodiment of the present invention can also be used in the circuit portion 164. When the display portion 162 includes the transistor of one embodiment of the present invention, the pixel size can be reduced and high resolution can be achieved. When the circuit portions 164 and 173 each include the transistor of one embodiment of the present invention, areas occupied by the circuit portions 164 and 173 can be reduced and a narrower bezel can be achieved. Furthermore, when one or more of the display portion 162 and the circuit portions 164 and 173 include the transistor of one embodiment of the present invention, the load of wirings can be reduced; thus, a display device capable of high-speed operation, a large-sized display device, or a display device with high resolution (with a large number of pixels) can be achieved. The description in the above embodiment can be referred to for the transistor of one embodiment of the present invention.

Note that the transistor included in the display device of this embodiment is not limited to a vertical transistor. For example, the display device of this embodiment may include a vertical transistor and a transistor having another structure in combination.

The display device of this embodiment may include one or more of a planar transistor, a staggered transistor, and an inverted staggered transistor. A transistor included in the display device of this embodiment may have a top-gate structure or a bottom-gate structure. Gates may be provided above and below a semiconductor layer where a channel is formed.

A transistor including silicon in its channel formation region (a Si transistor) may be included in the display device of this embodiment. Examples of the silicon include single crystal silicon, polycrystalline silicon, and amorphous silicon. In particular, a transistor including LTPS in its semiconductor layer (hereinafter also referred to as an LTPS transistor) can be used. An LTPS transistor has high field-effect mobility and excellent frequency characteristics. Amorphous silicon can be uniformly deposited over a large-area glass substrate; thus, a transistor including amorphous silicon in its semiconductor layer is excellent in productivity.

The display device of this embodiment may include a transistor including an oxide semiconductor (OS) typified by an In—Ga—Zn oxide (also referred to as IGZO) in its channel formation region (such a transistor is referred to as an OS transistor). For example, both a transistor including silicon in its semiconductor where a channel is formed and a transistor including an oxide semiconductor may be included in the display device.

The transistor included in the circuit portion 173 and the transistor included in the display portion 162 may have the same structure or different structures. One structure or two or more kinds of structures may be employed for a plurality of transistors included in the circuit portion 173. Similarly, one structure or two or more kinds of structures may be employed for a plurality of transistors included in the display portion 162. Note that the same applies to the circuit portion 164.

All of the transistors included in the display portion 162 may be OS transistors or Si transistors. Alternatively, some of the transistors included in the display portion 162 may be OS transistors and the others may be Si transistors.

For example, when both an LTPS transistor and an OS transistor are used in the display portion 162, the display device can have low power consumption and high drive capability. Note that a structure in which an LTPS transistor and an OS transistor are used in combination is referred to as LTPO in some cases. As a favorable example, a structure is given in which an OS transistor is used as a transistor functioning as a switch for controlling electrical continuity and discontinuity between wirings and an LTPS transistor is used as a transistor for controlling a current.

For example, one transistor included in the display portion 162 serves as a transistor for controlling a current flowing through the light-emitting element and can also be referred to as a driving transistor. One of a source and a drain of the driving transistor is electrically connected to a pixel electrode of the light-emitting element.

By contrast, another transistor included in the display portion 162 functions as a switch for controlling selection or non-selection of a pixel and can also be referred to as a selection transistor. A gate of the selection transistor is electrically connected to a gate line, and one of a source and a drain thereof is electrically connected to a source line (signal line). An OS transistor is preferably used as the selection transistor. Accordingly, the gray level of the pixel can be maintained even with an extremely low frame frequency (e.g., 1 fps or lower); thus, power consumption can be reduced by stopping the driver in displaying a still image.

An insulating layer 218 is provided to cover the transistors 205D, 205R, 205G, and 205B and an insulating layer 235 is provided over the insulating layer 218.

The insulating layer 218 preferably functions as a protective layer of the transistors. A material that does not easily allow diffusion of impurities such as water and hydrogen is preferably used for the insulating layer 218. This is because the insulating layer 218 can function as a barrier layer. Such a structure can effectively inhibit diffusion of impurities into the transistors from the outside and increase the reliability of the display device.

The insulating layer 218 preferably includes one or more inorganic insulating films. Examples of the inorganic insulating film include an oxide insulating film, a nitride insulating film, an oxynitride insulating film, and a nitride oxide insulating film. Specific examples of these inorganic insulating films are as described above.

The insulating layer 235 preferably has a function of a planarization layer, and an organic insulating film is suitably used. Examples of materials that can be used for the organic insulating film include an acrylic resin, a polyimide resin, an epoxy resin, a polyamide resin, a polyimide-amide resin, a siloxane resin, a benzocyclobutene-based resin, a phenol resin, and precursors of these resins. Alternatively, the insulating layer 235 may have a stacked-layer structure of an organic insulating film and an inorganic insulating film. The outermost layer of the insulating layer 235 preferably functions as an etching protective layer. In that case, the formation of a depression in the insulating layer 235 can be inhibited in processing pixel electrodes 111R, 111G, and 111B, for example. Alternatively, a depression may be formed in the insulating layer 235 in processing the pixel electrodes 111R, 111G, and 111B, for example.

The light-emitting elements 130R, 130G, and 130B are provided over the insulating layer 235.

The light-emitting element 130R includes the pixel electrode 111R over the insulating layer 235, an EL layer 113R over the pixel electrode 111R, and a common electrode 115 over the EL layer 113R. The light-emitting element 130R illustrated in FIG. 14 emits red light (R). The EL layer 113R includes a light-emitting layer that emits red light.

In a similar manner, the light-emitting element 130G includes the pixel electrode 111G, an EL layer 113G, and the common electrode 115. The light-emitting element 130G emits green light (G) and the EL layer 113G includes a light-emitting layer that emits green light.

In a similar manner, the light-emitting element 130B includes the pixel electrode 111B, an EL layer 113B, and the common electrode 115. The light-emitting element 130B emits blue light (B) and the EL layer 113B includes a light-emitting layer that emits blue light.

Although the EL layers 113R, 113G, and 113B have the same thickness in FIG. 14, the structure is not limited thereto. The EL layers 113R, 113G, and 113B may have different thicknesses. For example, the thicknesses of the EL layers 113R, 113G, and 113B are each preferably set in accordance with ab optical path length for intensifying light emitted from the EL layers 113R, 113G, and 113B. In that case, a microcavity structure is obtained, and the color purity of light emitted from each light-emitting element can be improved.

The pixel electrode 111R is electrically connected to the conductive layer 112b included in the transistor 205R through an opening provided in the insulating layers 106, 218, and 235. In a similar manner, the pixel electrode 111G is electrically connected to the conductive layer 112b included in the transistor 205G and the pixel electrode 111B is electrically connected to the conductive layer 112b included in the transistor 205B.

End portions of the pixel electrodes 111R, 111G, and 111B are covered with an insulating layer 237. The insulating layer 237 functions as a partition (also referred to as a bank or a spacer). The insulating layer 237 can have a single-layer structure or a stacked-layer structure including one or both of an inorganic insulating material and an organic insulating material. A material that can be used for the insulating layer 218 and a material that can be used for the insulating layer 235 can be used for the insulating layer 237, for example. The insulating layer 237 can electrically isolate the pixel electrode and the common electrode. Furthermore, the insulating layer 237 can electrically isolate light-emitting elements adjacent to each other.

The common electrode 115 is one continuous film shared by the light-emitting elements 130R, 130G, and 130B. The common electrode 115 shared by the light-emitting elements is electrically connected to a conductive layer 123 provided in the connection portion 140. The conductive layer 123 is preferably formed using a conductive layer formed using the same material through the same process as the pixel electrodes 111R, 111G, and 111B.

In the display device of one embodiment of the present invention, a conductive film that transmits visible light is used for the electrode through which light is extracted, which is either the pixel electrode or the common electrode. A conductive film reflecting visible light is preferably used for the electrode through which light is not extracted.

A conductive film that transmits visible light may be used also for the electrode through which light is not extracted. In that case, this electrode is preferably provided between a reflective layer and the EL layer. In other words, light emitted by the EL layer may be reflected by the reflective layer to be extracted from the display device.

As the material of the pair of electrodes of the light-emitting element, a metal, an alloy, an electrically conductive compound, a mixture thereof, or the like can be used as appropriate. Specific examples of the material include metals such as aluminum, magnesium, titanium, chromium, manganese, iron, cobalt, nickel, copper, gallium, zinc, indium, tin, molybdenum, tantalum, tungsten, palladium, gold, platinum, silver, yttrium, and neodymium, and an alloy containing any of these metals in appropriate combination. Other examples of the material include indium tin oxide (also referred to as In—Sn oxide or ITO), In—Si—Sn oxide (also referred to as ITSO), indium zinc oxide (In—Zn oxide), and In—W—Zn oxide. Other examples of the material include an alloy containing aluminum (aluminum alloy), such as an alloy of aluminum, nickel, and lanthanum (Al—Ni—La), and an alloy containing silver, such as an alloy of silver and magnesium (Mg—Ag) and an alloy of silver, palladium, and copper (Ag—Pd—Cu, also referred to as APC). Other examples of the material include an element belonging to Group 1 or Group 2 of the periodic table that is not described above (e.g., lithium, cesium, calcium, or strontium), a rare earth metal such as europium or ytterbium, an alloy containing an appropriate combination of any of these elements, and graphene.

The light-emitting element preferably employs a microcavity structure. Therefore, one of the pair of electrodes of the light-emitting element preferably includes an electrode having properties of transmitting and reflecting visible light (a transflective electrode), and the other preferably includes an electrode having a property of reflecting visible light (a reflective electrode). When the light-emitting element has a microcavity structure, light obtained from the light-emitting layer can be resonated between the electrodes, whereby light emitted from the light-emitting element can be intensified.

The transparent electrode has a light transmittance higher than or equal to 40%. For example, an electrode having a visible light (light with wavelengths greater than or equal to 400 nm and less than 750 nm) transmittance higher than or equal to 40% is preferably used as the transparent electrode of the light-emitting element. The transflective electrode has a visible light reflectance higher than or equal to 10% and lower than or equal to 95%, preferably higher than or equal to 30% and lower than or equal to 80%. The reflective electrode has a visible light reflectance higher than or equal to 40% and lower than or equal to 100%, preferably higher than or equal to 70% and lower than or equal to 100%. These electrodes preferably have a resistivity lower than or equal to 1×10⁻² Ωcm.

The EL layers 113R, 113G, and 113B are each provided to have an island shape. In FIG. 14, end portions of the EL layers 113R and 113G adjacent to each other overlap with each other, end portions of the EL layers 113G and 113B adjacent to each other overlap with each other, and end portions of the EL layers 113R and 113B adjacent to each other overlap with each other. When island-shaped EL layers are deposited using a fine metal mask, end portions of the EL layers adjacent to each other may overlap with each other as illustrated in FIG. 14; however, the structure is not limited thereto. That is, it is also possible that the EL layers adjacent to each other do not overlap with each other and are apart from each other. It is also possible that the display device includes both a portion where the EL layers adjacent to each other overlap with each other and a portion where the EL layers adjacent to each other do not overlap with each other and are apart from each other.

Each of the EL layers 113R, 113G, and 113B includes at least a light-emitting layer. The light-emitting layer contains one or more kinds of light-emitting substances. As the light-emitting substance, a substance whose emission color is blue, violet, bluish violet, green, yellowish green, yellow, orange, red, or the like is appropriately used. Alternatively, as the light-emitting substance, a substance that emits near-infrared light can be used.

Examples of the light-emitting substance include a fluorescent material, a phosphorescent material, a TADF material, and a quantum dot material.

The light-emitting layer may contain one or more kinds of organic compounds (e.g., a host material or an assist material) in addition to the light-emitting substance (a guest material). As one or more kinds of organic compounds, one or both of a substance with a good hole-transport property (a hole-transport material) and a substance with a good electron-transport property (an electron-transport material) can be used. As the one or more kinds of organic compounds, a substance with a bipolar property (a substance with high electron-transport and hole-transport properties, also referred to as a bipolar material) or a TADF material may be used.

The light-emitting layer preferably includes a phosphorescent material and a combination of a hole-transport material and an electron-transport material that easily forms an exciplex, for example. With such a structure, light emission can be efficiently obtained by exciplex-triplet energy transfer (ExTET), which is energy transfer from the exciplex to the light-emitting substance (phosphorescent material). When a combination of materials is selected so as to form an exciplex that emits light whose wavelength overlaps with the wavelength of a lowest-energy-side absorption band of the light-emitting substance, energy can be transferred smoothly and light emission can be obtained efficiently. With the above structure, high efficiency, low-voltage driving, and a long lifetime of a light-emitting element can be achieved at the same time.

In addition to the light-emitting layer, the EL layer can include one or more of a layer containing a substance having a good hole-injection property (a hole-injection layer), a layer containing a hole-transport material (a hole-transport layer), a layer containing a substance having a good electron-blocking property (an electron-blocking layer), a layer containing a substance having a good electron-injection property (an electron-injection layer), a layer containing an electron-transport material (an electron-transport layer), and a layer containing a substance having a good hole-blocking property (a hole-blocking layer). The EL layer may further include one or both of a bipolar material and a TADF material.

Either a low molecular compound or a high molecular compound can be used in the light-emitting element, and an inorganic compound may also be included. Each layer included in the light-emitting element can be formed by any of the following methods: an evaporation method (including a vacuum evaporation method), a transfer method, a printing method, an inkjet method, a coating method, and the like.

The light-emitting element may employ a single structure (a structure including only one light-emitting unit) or a tandem structure (a structure including a plurality of light-emitting units). The light-emitting unit includes at least one light-emitting layer. In a tandem structure, a plurality of light-emitting units are connected in series with a charge-generation layer therebetween. The charge-generation layer has a function of injecting electrons into one of two light-emitting units and injecting holes to the other when a voltage is applied between the pair of electrodes. The tandem structure enables a light-emitting element capable of high-luminance light emission. Furthermore, the tandem structure reduces the amount of current needed for obtaining the same luminance as compared with a single structure, and thus can improve the reliability. A tandem structure may be referred to as a stack structure.

In the case of using a tandem light-emitting element in FIG. 14, for example, the EL layer 113R preferably includes a plurality of light-emitting units that emit red light, the EL layer 113G preferably includes a plurality of light-emitting units that emit green light, and the EL layer 113B preferably includes a plurality of light-emitting units that emit blue light.

A protective layer 131 is provided over the light-emitting elements 130R, 130G, and 130B. The protective layer 131 and the substrate 152 are bonded to each other with an adhesive layer 142. The substrate 152 is provided with a light-blocking layer 117. A solid sealing structure, a hollow sealing structure, or the like can be employed to seal the light-emitting elements. In FIG. 14, a solid sealing structure is employed, in which a space between the substrate 152 and the substrate 151 is filled with the adhesive layer 142. Alternatively, a hollow sealing structure may be employed, in which the space is filled with an inert gas (e.g., nitrogen or argon). In that case, the adhesive layer 142 may be provided not to overlap with the light-emitting element. Alternatively, the space may be filled with a resin other than the frame-like adhesive layer 142.

The protective layer 131 is provided at least in the display portion 162, and preferably provided to cover the entire display portion 162. By providing the protective layer 131 over the light-emitting elements 130R, 130G, and 130B, the reliability of the light-emitting elements can be increased. The protective layer 131 is preferably provided to cover not only the display portion 162 but also the connection portion 140, the circuit portion 173, and the circuit portion 164. It is further preferable that the protective layer 131 be provided to extend to the end portion of the display device 100A. Meanwhile, a connection portion 204 has a portion not provided with the protective layer 131 so that the FPC 172 and a conductive layer 166 are electrically connected to each other.

The protective layer 131 can have a single-layer structure or a stacked structure of two or more layers. There is no limitation on the conductivity of the protective layer 131. For the protective layer 131, at least one of an insulating film, a semiconductor film, and a conductive film can be used. The protective layer 131 including an inorganic film can inhibit deterioration of the light-emitting elements by preventing oxidation of the common electrode 115 and inhibiting entry of impurities (e.g., moisture and oxygen) into the light-emitting elements, for example; thus, the reliability of the display device can be improved. For the protective layer 131, an inorganic insulating film such as an oxide insulating film, a nitride insulating film, an oxynitride insulating film, or a nitride oxide insulating film can be used, for example. Specific examples of these inorganic insulating films are as described above. In particular, the protective layer 131 preferably includes a nitride insulating film or a nitride oxide insulating film, and further preferably includes a nitride insulating film.

An inorganic film containing ITO, In—Zn oxide, Ga—Zn oxide, Al—Zn oxide, IGZO, or the like can be used for the protective layer 131. The inorganic film preferably has high resistance, specifically, higher resistance than the common electrode 115. The inorganic film may further contain nitrogen.

When light emitted from the light-emitting element is extracted through the protective layer 131, the protective layer 131 preferably has a good visible-light-transmitting property. For example, ITO, IGZO, and aluminum oxide are preferable because they are inorganic materials having a good property of transmitting visible light.

The protective layer 131 can be, for example, a stack of an aluminum oxide film and a silicon nitride film over the aluminum oxide film, or a stack of an aluminum oxide film and an IGZO film over the aluminum oxide film. Such a stacked-layer structure can inhibit entry of impurities (e.g., water and oxygen) into the EL layer.

Furthermore, the protective layer 131 may include an organic film. For example, the protective layer 131 may include both an organic film and an inorganic film. Examples of an organic film that can be used for the protective layer 131 include organic insulating films that can be used for the insulating layer 235.

The connection portion 204 is provided in a region of the substrate 151 not overlapping with the substrate 152. In the connection portion 204, the wiring 165 is electrically connected to the FPC 172 through the conductive layer 166 and a connection layer 242. In this example, the wiring 165 is a single conductive layer obtained by processing the same conductive film as the conductive layer 112b. In this example, the conductive layer 166 is a single conductive layer obtained by processing the same conductive film as the pixel electrodes 111R, 111G, and 111B. On the top surface of the connection portion 204, the conductive layer 166 is exposed. Thus, the connection portion 204 and the FPC 172 can be electrically connected to each other through the connection layer 242.

The display device 100A is a top-emission display device. Light from the light-emitting element is emitted toward the substrate 152. For the substrate 152, a material having a good visible-light-transmitting property is preferably used. The pixel electrodes 111R, 111G, and 111B contain a material that reflects visible light, and the counter electrode (the common electrode 115) contains a material that transmits visible light.

The light-blocking layer 117 is preferably provided on the surface of the substrate 152 on the substrate 151 side. The light-blocking layer 117 can be provided over a region between adjacent light-emitting elements, in the connection portion 140, in the circuit portion 173, in the circuit portion 164, and the like.

A coloring layer such as a color filter may be provided on the surface of the substrate 152 on the substrate 151 side or over the protective layer 131. When the color filter is provided so as to overlap with the light-emitting element, the color purity of light emitted from the pixel can be increased.

Moreover, a variety of optical members can be provided on the outer surface of the substrate 152 (the surface opposite to the substrate 151). Examples of the optical members include a polarizing plate, a retardation plate, a light diffusion layer (e.g., a diffusion film), an anti-reflective layer, and a light-condensing film. Furthermore, an antistatic film inhibiting the attachment of dust, a water repellent film inhibiting the attachment of stain, a hard coat film inhibiting generation of a scratch caused by the use, an impact-absorbing layer, or the like may be provided as a surface protective layer on the outer surface of the substrate 152. For example, a glass layer or a silica layer (SiOₓ layer) is preferably provided as the surface protective layer to inhibit the surface contamination and damage. The surface protective layer may be formed using diamond-like carbon (DLC), aluminum oxide (AlOₓ), a polyester-based material, a polycarbonate-based material, or the like. For the surface protective layer, a material having a high visible light transmittance is preferably used. The surface protective layer is preferably formed using a material with high hardness.

For each of the substrates 151 and 152, glass, quartz, ceramic, sapphire, a resin, a metal, an alloy, a semiconductor, or the like can be used. The substrate on the side from which light from the light-emitting element is extracted is formed using a material that transmits the light. When a flexible material is used for the substrates 151 and 152, the display device can have increased flexibility and a flexible display can be obtained. Furthermore, a polarizing plate may be used as at least one of the substrates 151 and 152.

For each of the substrates 151 and 152, any of the following can be used, for example: polyester resins such as polyethylene terephthalate (PET) and polyethylene naphthalate (PEN), a polyacrylonitrile resin, an acrylic resin, a polyimide resin, a polymethyl methacrylate resin, a polycarbonate (PC) resin, a polyethersulfone (PES) resin, polyamide resins (e.g., nylon and aramid), a polysiloxane resin, a cycloolefin resin, a polystyrene resin, a polyamide-imide resin, a polyurethane resin, a polyvinyl chloride resin, a polyvinylidene chloride resin, a polypropylene resin, a polytetrafluoroethylene (PTFE) resin, an ABS resin, and cellulose nanofiber. Glass that is thin enough to have flexibility may be used as at least one of the substrates 151 and 152.

In the case where a circularly polarizing plate overlaps with the display device, a highly optically isotropic substrate is preferably used as the substrate included in the display device. A highly optically isotropic substrate has a low birefringence (in other words, a small amount of birefringence). Examples of the film having high optical isotropy include a triacetyl cellulose (TAC, also referred to as cellulose triacetate) film, a cycloolefin polymer (COP) film, a cycloolefin copolymer (COC) film, and an acrylic film.

The adhesive layer 142 can be formed using any of a variety of curable adhesives, e.g., a reactive curable adhesive, a thermosetting curable adhesive, an anaerobic adhesive, or a photocurable adhesive such as an ultraviolet curable adhesive. Examples of these adhesives include an epoxy resin, an acrylic resin, a silicone resin, a phenol resin, a polyimide resin, an imide resin, a polyvinyl chloride (PVC) resin, a polyvinyl butyral (PVB) resin, and an ethylene vinyl acetate (EVA) resin. In particular, a material with low moisture permeability, such as an epoxy resin, is preferable. A two-component-mixture-type resin may be used. An adhesive sheet or the like may be used.

For the connection layer 242, an anisotropic conductive film (ACF), an anisotropic conductive paste (ACP), or the like can be used.

### [Display Device 100B]

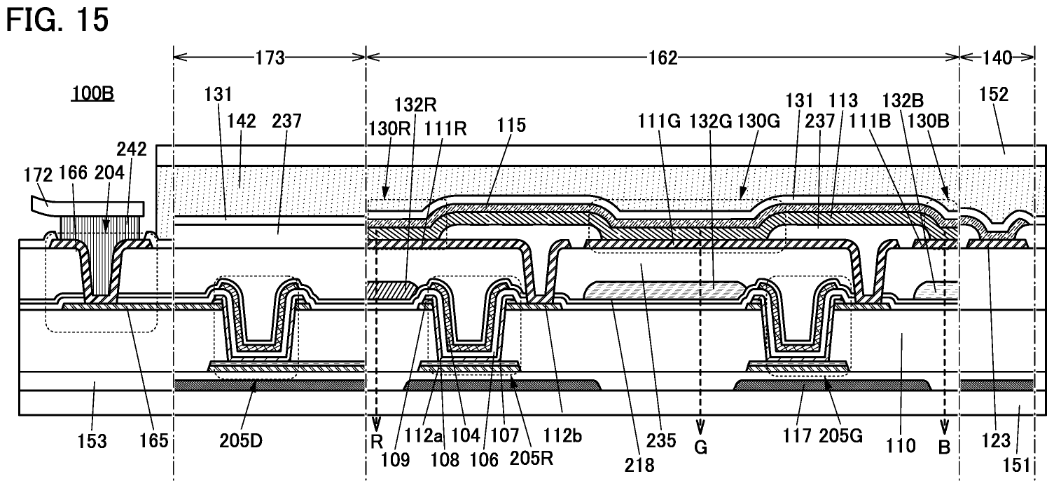

A display device 100B illustrated in FIG. 15 is different from the display device 100A mainly in being a bottom-emission display device and in that the subpixels of different colors include respective coloring layers (color filters or the like) and an EL layer 113 shared by the light-emitting elements, for example. Note that in the following description of display devices, the description of portions similar to those of the above-described display devices may be omitted.

Light from the light-emitting element is emitted toward the substrate 151. For the substrate 151, a material having a good visible-light-transmitting property is preferably used. By contrast, there is no limitation on the light-transmitting property of a material used for the substrate 152.

In the display device 100B illustrated in FIG. 15, the transistors 205D, 205R, 205G, and 205B (not illustrated), the light-emitting elements 130R, 130G, and 130B, a coloring layer 132R transmitting red light, a coloring layer 132G transmitting green light, a coloring layer 132B transmitting blue light, and the like are provided between the substrates 151 and 152.

The light-emitting element 130R includes the pixel electrode 111R, the EL layer 113 over the pixel electrode 111R, and the common electrode 115 over the EL layer 113. Light emitted from the light-emitting element 130R is extracted as red light to the outside of the display device 100B through the coloring layer 132R.

The light-emitting element 130G includes the pixel electrode 111G, the EL layer 113 over the pixel electrode 111G, and the common electrode 115 over the EL layer 113. Light emitted from the light-emitting element 130G is extracted as green light to the outside of the display device 100B through the coloring layer 132G.

The light-emitting element 130B includes the pixel electrode 111B, the EL layer 113 over the pixel electrode 111B, and the common electrode 115 over the EL layer 113. Light emitted from the light-emitting element 130B is extracted as blue light to the outside of the display device 100B through the coloring layer 132B.

The EL layer 113 and the common electrode 115 are shared by the light-emitting elements 130R, 130G, and 130B. The number of manufacturing steps can be smaller in the case where the EL layer 113 is shared by the subpixels of different colors than the case where the subpixels of different colors include different EL layers.

The light-emitting elements 130R, 130G, and 130B shown in FIG. 15 emit white light, for example. When white light emitted from the light-emitting elements 130R, 130G, and 130B passes through the coloring layers 132R, 132G, and 132B, light of desired colors can be obtained.

The light-blocking layer 117 is preferably formed between the substrate 151 and the transistor. In the example illustrated in FIG. 15, the light-blocking layers 117 are provided over the substrate 151, an insulating layer 153 is provided over the light-blocking layers 117, and the transistor 205D, the transistor 205R, the transistor 205G, the transistor 205B (not illustrated), and the like are provided over the insulating layer 153. In addition, the coloring layers 132R, 132G, and 132B are provided over the insulating layer 218 and the insulating layer 235 is provided over the coloring layers 132R, 132G, and 132B.

A material having a high visible-light-transmitting property is used for each of the pixel electrodes 111R, 111G, and 111B. A material that reflects visible light is preferably used for the common electrode 115. In the display device having a bottom-emission structure, a metal or the like having low resistance can be used for the common electrode 115; thus, a voltage drop due to the resistance of the common electrode 115 can be suppressed and the display quality can be high.

The transistor of one embodiment of the present invention can be miniaturized and the area occupied by the transistor can be reduced, so that the aperture ratio of the pixel can be increased or the pixel size can be reduced in the display device having a bottom-emission structure.

In the case of employing a microcavity structure for each of the light-emitting elements 130R, 130G, and 130B, light that is white light emitted from the EL layer 113 and in which a specific wavelength is intensified is emitted. Here, even with such a microcavity structure, a light-emitting element including an EL layer that emits white light is referred to as a white-light-emitting element.

A white-light-emitting element preferably includes two or more light-emitting layers. When two light-emitting layers are used to obtain white light, two light-emitting layers that emit light of complementary colors can be selected. For example, when the emission colors of the first light-emitting layer and the second light-emitting layer are made complementary, the light-emitting element can be configured to emit white light as a whole. In the case where three or more light-emitting layers are used to obtain white light, the light-emitting element can be configured to emit white light as a whole by combining emission colors of the three or more light-emitting layers.

For example, the EL layer 113 preferably includes a light-emitting layer containing a light-emitting substance that emits blue light and a light-emitting layer containing a light-emitting substance that emits visible light having a longer wavelength than blue light. The EL layer 113 preferably includes a light-emitting layer that emits yellow light and a light-emitting layer that emits blue light, for example. Alternatively, the EL layer 113 preferably includes a light-emitting layer that emits red light, a light-emitting layer that emits green light, and a light-emitting layer that emits blue light, for example.

A light-emitting element that emits white light preferably has a tandem structure. Specific examples include a two-unit tandem structure including a light-emitting unit that emits yellow light and a light-emitting unit that emits blue light; a two-unit tandem structure including a light-emitting unit that emits red light and green light and a light-emitting unit that emits blue light; a three-unit tandem structure in which a light-emitting unit that emits blue light, a light-emitting unit that emits yellow, yellow-green, or green light, and a light-emitting unit that emits blue light are stacked in this order; and a three-unit tandem structure in which a light-emitting unit that emits blue light, a light-emitting unit that emits yellow, yellow-green, or green light and red light, and a light-emitting unit that emits blue light are stacked in this order. Examples of the number of stacked light-emitting units and the order of colors from the anode side include a two-unit structure of B and Y; a two-unit structure of B and a light-emitting unit X; a three-unit structure of B, Y, and B; and a three-unit structure of B, X, and B. Examples of the number of light-emitting layers stacked in the light-emitting unit X and the order of colors from an anode side include a two-layer structure of R and Y; a two-layer structure of R and G; a two-layer structure of G and R; a three-layer structure of G, R, and G; and a three-layer structure of R, G, and R. Another layer may be provided between two light-emitting layers.

Alternatively, the light-emitting elements 130R, 130G, and 130B illustrated in FIG. 15 may be configured to emit blue light, for example. In this case, the EL layer 113 includes one or more light-emitting layers that emit blue light. In the subpixel 210B that emits blue light, blue light emitted by the light-emitting element 130B can be extracted. In each of the subpixel 210R emitting red light and the subpixel 210G emitting green light, a color conversion layer is provided between the light-emitting element 130R or 130G and the substrate 151 so that blue light emitted by the light-emitting element 130R or 130G is converted into light with a longer wavelength, whereby red light or green light can be extracted. Furthermore, it is preferable that the coloring layer 132R be provided between the color conversion layer and the substrate 151 on an optical path of light emitted by the light-emitting element 130R, and the coloring layer 132G be provided between the color conversion layer and the substrate 151 on an optical path of light emitted by the light-emitting element 130G. In some cases, part of light emitted by the light-emitting element is transmitted through the color conversion layer without being converted. When light transmitted through the color conversion layer is extracted through the coloring layer, light other than light of the intended color can be absorbed by the coloring layer, and color purity of light exhibited by a subpixel can be improved.

### [Display Device 100C]

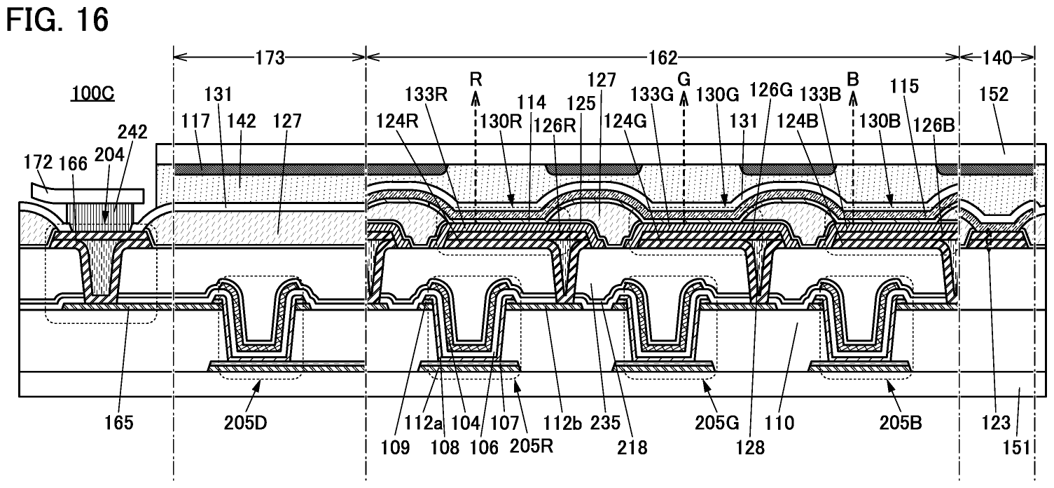

A display device 100C shown in FIG. 16 is an example of a display device having a metal maskless (MML) structure. In other words, the display device 100C includes a light-emitting element that is formed without using a fine metal mask. A stacked-layer structure from the substrate 151 to the insulating layer 235 and a stacked-layer structure from the protective layer 131 to the substrate 152 are similar to those in the display device 100A; therefore, description thereof is omitted.

In FIG. 16, the light-emitting elements 130R, 130G, and 130B are provided over the insulating layer 235.

The light-emitting element 130R includes a conductive layer 124R over the insulating layer 235, a conductive layer 126R over the conductive layer 124R, a layer 133R over the conductive layer 126R, a common layer 114 over the layer 133R, and the common electrode 115 over the common layer 114. The light-emitting element 130R shown in FIG. 16 emits red light (R). The layer 133R includes a light-emitting layer that emits red light. In the light-emitting element 130R, the layer 133R and the common layer 114 can be collectively referred to as an EL layer. One or both of the conductive layer 124R and the conductive layer 126R can be referred to as a pixel electrode.

In a similar manner, the light-emitting element 130G includes a conductive layer 124G over the insulating layer 235, a conductive layer 126G over the conductive layer 124G, a layer 133G over the conductive layer 126G, the common layer 114 over the layer 133G, and the common electrode 115 over the common layer 114. The light-emitting element 130G illustrated in FIG. 16 emits green light (G). The layer 133G includes a light-emitting layer that emits green light.

In a similar manner, the light-emitting element 130B includes a conductive layer 124B over the insulating layer 235, a conductive layer 126B over the conductive layer 124B, a layer 133B over the conductive layer 126B, the common layer 114 over the layer 133B, and the common electrode 115 over the common layer 114. The light-emitting element 130B illustrated in FIG. 16 emits blue light (B). The layer 133B includes a light-emitting layer that emits blue light.

In this specification and the like, in the EL layers included in the light-emitting elements, the island-shaped layer provided in each light-emitting element is referred to as the layer 133B, the layer 133G, or the layer 133R, and the layer shared by the light-emitting elements is referred to as the common layer 114. Note that in this specification and the like, only the layers 133R, 133G, and 133B are sometimes referred to as island-shaped EL layers, EL layers formed in an island shape, or the like, in which case the common layer 114 is not included in the EL layer.

The layers 133R, 133G, and 133B are isolated from each other. When the EL layer is provided to have an island shape for each light-emitting element, a leakage current between adjacent light-emitting elements can be inhibited. This can prevent crosstalk-induced unintended light emission, so that the display device can achieve extremely high contrast.

Although the layers 133R, 133G, and 133B have the same thickness in FIG. 16, the structure is not limited thereto. The layers 133R, 133G, and 133B may have different thicknesses.

The conductive layer 124R is electrically connected to the conductive layer 112b included in the transistor 205R through an opening provided in the insulating layers 106, 218, and 235. In a similar manner, the conductive layer 124G is electrically connected to the conductive layer 112b included in the transistor 205G and the conductive layer 124B is electrically connected to the conductive layer 112b included in the transistor 205B.

The conductive layers 124R, 124G, and 124B are formed to cover the openings provided in the insulating layer 235. A layer 128 is embedded in each of the depressions of the conductive layers 124R, 124G, and 124B.

The layer 128 has a function of filling the depressions of the conductive layers 124R, 124G, and 124B. The conductive layers 126R, 126G, and 126B electrically connected to the conductive layers 124R, 124G, and 124B, respectively, are provided over the conductive layers 124R, 124G, and 124B and the layer 128. Thus, regions overlapping with the depressions of the conductive layers 124R, 124G, and 124B can also be used as the light-emitting regions, increasing the aperture ratio of the pixels. The conductive layer 124R and the conductive layer 126R each preferably include a conductive layer functioning as a reflective electrode.

The layer 128 may be an insulating layer or a conductive layer. Any of a variety of inorganic insulating materials, organic insulating materials, and conductive materials can be used for the layer 128 as appropriate. Specifically, the layer 128 is preferably formed using an insulating material and is particularly preferably formed using an organic insulating material. For the layer 128, an organic insulating material that can be used for the insulating layer 237 can be used, for example.

Although the top surface of the layer 128 includes a flat portion in the example illustrated in FIG. 16, the shape of the layer 128 is not particularly limited. The top surface of the layer 128 may include at least one of a convex surface, a concave surface, and a flat surface.

The level of the top surface of the layer 128 and the level of the top surface of the conductive layer 124R may be the same or substantially the same, or may be different from each other. For example, the level of the top surface of the layer 128 may be either lower or higher than the level of the top surface of the conductive layer 124R.

An end portion of the conductive layer 126R may be aligned with an end portion of the conductive layer 124R or may cover the side surface of the end portion of the conductive layer 124R. The end portions of the conductive layers 124R and 126R each preferably have a tapered shape. Specifically, the end portions of the conductive layers 124R and 126R each preferably have a tapered shape with a taper angle less than 90°. In the case where the end portions of the pixel electrodes have a tapered shape, the layer 133R provided along side surfaces of the pixel electrodes has an inclined portion. When the side surface of the pixel electrode has a tapered shape, coverage with an EL layer provided along the side surface of the pixel electrode can be improved.

Since the conductive layers 124G and 126G and the conductive layers 124B and 126B are similar to the conductive layers 124R and 126R, the detailed description thereof is omitted.

The top and side surfaces of the conductive layer 126R are covered with the layer 133R. Similarly, the top and side surfaces of the conductive layers 126G are covered with the layer 133G, and the top and side surfaces of the conductive layers 126B are covered with the layer 133B. Accordingly, regions provided with the conductive layers 126R, 126G, and 126B can be entirely used as the light-emitting regions of the light-emitting elements 130R, 130G, and 130B, thereby increasing the aperture ratio of the pixels.

The side surface and part of the top surface of each of the layers 133R, 133G, and 133B are covered with insulating layers 125 and 127. The common layer 114 is provided over the layers 133R, 133G, and 133B and the insulating layers 125 and 127, and the common electrode 115 is provided over the common layer 114. The common layer 114 and the common electrode 115 are each one continuous film shared by a plurality of light-emitting elements.

In FIG. 16, the insulating layer 237 illustrated in FIG. 14 or the like is not provided between the conductive layer 126R and the layer 133R. That is, an insulating layer (also referred to as a partition wall, a bank, a spacer, or the like) covering and in contact with a top end portion of the pixel electrode is not provided in the display device 100C. Thus, the interval between adjacent light-emitting elements can be extremely shortened. Accordingly, the display device can have high resolution or high definition. In addition, a mask for forming the insulating layer is not needed, which leads to a reduction in manufacturing cost of the display device.

As described above, the layers 133R, 133G, and 133B each include a light-emitting layer. The layers 133R, 133G, and 133B each preferably include a light-emitting layer and a carrier-transport layer (an electron-transport layer or a hole-transport layer) over the light-emitting layer. Alternatively, the layers 133R, 133G, and 133B each preferably include a light-emitting layer and a carrier-blocking layer (a hole-blocking layer or an electron-blocking layer) over the light-emitting layer. Alternatively, the layers 133R, 133G, and 133B each preferably include a light-emitting layer, a carrier-blocking layer over the light-emitting layer, and a carrier-transport layer over the carrier-blocking layer. Since surfaces of the layers 133R, 133G, and 133B are exposed in the manufacturing process of the display device, providing one or both of the carrier-transport layer and the carrier-blocking layer over the light-emitting layer inhibits the light-emitting layer from being exposed on the outermost surface, so that damage to the light-emitting layer can be reduced. Thus, the reliability of the light-emitting element can be increased.

The common layer 114 includes, for example, an electron-injection layer or a hole-injection layer. Alternatively, the common layer 114 may be a stack of an electron-transport layer and an electron-injection layer, or may be a stack of a hole-transport layer and a hole-injection layer. The common layer 114 is shared by the light-emitting elements 130R, 130G, and 130B.

The side surfaces of the layers 133R, 133G, and 133B are each covered with the insulating layer 125. The insulating layer 127 covers the side surfaces of the layers 133R, 133G, and 133B with the insulating layer 125 therebetween.

The side surfaces (and part of the top surfaces) of the layers 133R, 133G, and 133B are covered with at least one of the insulating layers 125 and 127, so that the common layer 114 (or the common electrode 115) can be inhibited from being in contact with the side surfaces of the pixel electrodes and the layers 133R, 133G, and 133B, leading to inhibition of a short circuit of the light-emitting elements. Thus, the reliability of the light-emitting element can be increased.

The insulating layer 125 is preferably in contact with the side surfaces of the layers 133R, 133G, and 133B. The insulating layer 125 in contact with the layers 133R, 133G, and 133B can prevent film separation of the layers 133R, 133G, and 133B, whereby the reliability of the light-emitting elements can be increased.

The insulating layer 127 is provided over the insulating layer 125 to fill a depression of the insulating layer 125. The insulating layer 127 preferably covers at least part of the side surface of the insulating layer 125.

The insulating layers 125 and 127 can fill a gap between adjacent island-shaped layers, whereby the formation surface of the layers (e.g., the carrier-injection layer and the common electrode) provided over the island-shaped layers can have higher flatness with small unevenness. Consequently, coverage with the carrier-injection layer, the common electrode, and the like can be improved.

The common layer 114 and the common electrode 115 are provided over the layers 133R, 133G, and 133B and the insulating layers 125 and 127. Before the insulating layers 125 and 127 are provided, a step is generated due to a level difference between a region where the pixel electrode and the island-shaped EL layer are provided and a region where neither the pixel electrode nor the island-shaped EL layer is provided (a region between the light-emitting elements). In the display device of one embodiment of the present invention, the insulating layers 125 and 127 can eliminate the level difference and improve the coverage with the common layer 114 and the common electrode 115. Thus, connection defects caused by step disconnection can be inhibited. In addition, an increase in electric resistance, which is caused by local thinning of the common electrode 115 due to the step, can be inhibited.

The top surface of the insulating layer 127 preferably has a shape with high flatness. The top surface of the insulating layer 127 may include at least one of a flat surface, a convex surface, and a concave surface. For example, the top surface of the insulating layer 127 preferably has a smooth convex shape with high flatness.

The insulating layer 125 can be formed using an inorganic material. For the insulating layer 125, an inorganic insulating film such as an oxide insulating film, a nitride insulating film, an oxynitride insulating film, or a nitride oxide insulating film can be used, for example. Specific examples of these inorganic insulating films are as described above. The insulating layer 125 may have a single-layer structure or a stacked-layer structure. In particular, aluminum oxide is preferably used because it has high selectivity with respect to the EL layer in etching and has a function of protecting the EL layer when the insulating layer 127 is formed. In particular, when an inorganic insulating film such as an aluminum oxide film, a hafnium oxide film, or a silicon oxide film is formed by an ALD method as the insulating layer 125, the insulating layer 125 can have few pinholes and an excellent function of protecting the EL layer. The insulating layer 125 may have a stacked-layer structure of a film formed by an ALD method and a film formed by a sputtering method. For example, the insulating layer 125 may have a stacked-layer structure of an aluminum oxide film formed by an ALD method and a silicon nitride film formed by a sputtering method.

The insulating layer 125 preferably has a function of a barrier insulating layer against at least one of water and oxygen. The insulating layer 125 preferably has a function of inhibiting diffusion of at least one of water and oxygen. Alternatively, the insulating layer 125 preferably has a function of capturing or fixing (also referred to as gettering) at least one of water and oxygen.

Note that in this specification and the like, a barrier insulating layer refers to an insulating layer having a barrier property. A barrier property in this specification and the like means a function of inhibiting diffusion of a particular substance (also referred to as a function of less easily transmitting the substance). Alternatively, a barrier property refers to a function of capturing or fixing (also referred to as gettering) a particular substance.

When the insulating layer 125 has a function of a barrier insulating layer or a gettering function, entry of impurities (typically, at least one of water and oxygen) that would be diffused into the light-emitting elements from the outside can be inhibited. With this structure, a highly reliable light-emitting element and a highly reliable display device can be provided.

The insulating layer 125 preferably has a low impurity concentration. Accordingly, degradation of the EL layer, which is caused by entry of impurities into the EL layer from the insulating layer 125, can be inhibited. In addition, when the impurity concentration is reduced in the insulating layer 125, a barrier property against at least one of water and oxygen can be increased. For example, the insulating layer 125 preferably has a sufficiently low hydrogen concentration or a sufficiently low carbon concentration, and further preferably has both a sufficiently low hydrogen concentration and a sufficiently low carbon concentration.

The insulating layer 127 provided over the insulating layer 125 has a function of filling large unevenness of the insulating layer 125, which is formed between the adjacent light-emitting elements. In other words, the insulating layer 127 has an effect of improving the flatness of the formation surface of the common electrode 115.

As the insulating layer 127, an insulating layer containing an organic material can be favorably used. As the organic material, a photosensitive organic resin is preferably used, and for example, a photosensitive resin composite containing an acrylic resin is preferably used. Note that in this specification and the like, an acrylic resin refers to not only a polymethacrylic acid ester or a methacrylic resin, but also all the acrylic polymer in a broad sense in some cases.

Alternatively, the insulating layer 127 may be formed using an acrylic resin, a polyimide resin, an epoxy resin, an imide resin, a polyamide resin, a polyimide-amide resin, a silicone resin, a siloxane resin, a benzocyclobutene-based resin, a phenol resin, precursors of these resins, or the like. The insulating layer 127 may be formed using an organic material such as polyvinyl alcohol (PVA), polyvinyl butyral, polyvinylpyrrolidone, polyethylene glycol, polyglycerin, pullulan, water-soluble cellulose, or an alcohol-soluble polyamide resin. A photoresist may be used as the photosensitive organic resin. As the photosensitive organic resin, either a positive-type material or a negative-type material may be used.

The insulating layer 127 may be formed using a material absorbing visible light. When the insulating layer 127 absorbs light emitted from the light-emitting element, light leakage (stray light) from the light-emitting element to the adjacent light-emitting element through the insulating layer 127 can be reduced. Thus, the display quality of the display device can be improved. Since no polarizing plate is required to improve the display quality of the display device, the weight and thickness of the display device can be reduced.

Examples of the material absorbing visible light include a material containing a pigment of black or any other color, a material containing a dye, a light-absorbing resin material (e.g., polyimide), and a resin material that can be used for color filters (a color filter material). Using a resin material obtained by stacking or mixing color filter materials of two or three or more colors is particularly preferred to enhance the effect of blocking visible light. In particular, mixing color filter materials of three or more colors enables the formation of a black or nearly black resin layer.

### [Display Device 100D]

Light-emitting elements are used as display elements in the above-described example, whereas the following example below shows a liquid crystal display device where liquid crystal elements are used as display elements.

Any of elements with various structures can be used as the liquid crystal elements included in the display device. Typically, liquid crystal elements employing a vertical alignment (VA) mode, a fringe field switching (FFS) mode, an in-plane switching (IPS) mode, or the like can be used. The display device including liquid crystal elements may be a transmissive liquid crystal display device or a reflective or semi-transmissive liquid crystal display device. The display device is preferably a normally black liquid crystal display device.

Examples of the VA mode include a multi-domain vertical alignment (MVA) mode, a patterned vertical alignment (PVA) mode, and an advanced super view (ASV) mode.

The liquid crystal element can employ a variety of modes. The liquid crystal element can employ, for example, a twisted nematic (TN) mode, an axially symmetric aligned micro-cell (ASM) mode, an optically compensated birefringence (OCB) mode, a ferroelectric liquid crystal (FLC) mode, an antiferroelectric liquid crystal (AFLC) mode, an electrically controlled birefringence (ECB) mode, or a guest-host mode, in addition to the VA mode, an FFS mode, and an IPS mode.

Here, the liquid crystal display device is a display device that controls transmission and non-transmission of light by utilizing polarized light and an optical modulation action of a liquid crystal. The optical modulation action of a liquid crystal is controlled by an electric field applied to the liquid crystal (including a horizontal electric field, a vertical electric field, or an oblique electric field). As the liquid crystal that can be used for the liquid crystal element, a thermotropic liquid crystal, a low-molecular liquid crystal, a high-molecular liquid crystal, a polymer dispersed liquid crystal (PDLC), a polymer network liquid crystal (PNLC), a ferroelectric liquid crystal, an anti-ferroelectric liquid crystal, or the like can be used. Such a liquid crystal material exhibits a cholesteric phase, a smectic phase, a cubic phase, a chiral nematic phase, an isotropic phase, or the like depending on conditions. As the liquid crystal material, either a positive liquid crystal or a negative liquid crystal may be used, and an appropriate liquid crystal material can be used depending on the mode or design to be used.

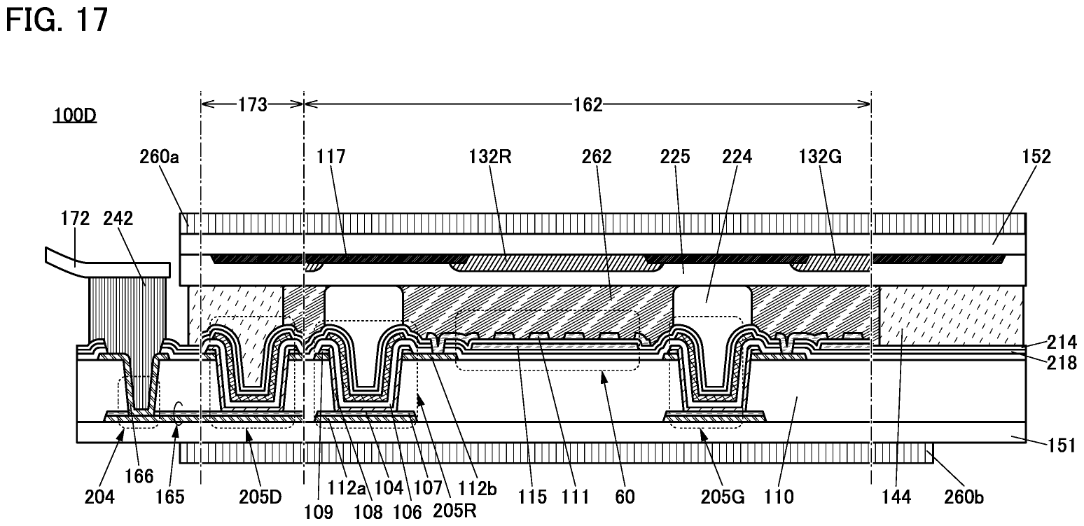

A display device 100D illustrated in FIG. 17 is an FFS liquid crystal display device.

The substrates 151 and 152 are bonded to each other with an adhesive layer 144. A region surrounded by the substrates 151 and 152 and the adhesive layer 144 is filled with liquid crystal 262. A polarizing plate 260a is positioned on the outer surface of the substrate 152, and a polarizing plate 260b is positioned on the outer surface of the substrate 151. Although not illustrated, a backlight can be provided outside the polarizing plate 260a or 260b.

The substrate 151 is provided with the transistors 205D, 205R, 205G, and 205B (not shown), the connection portion 204, a spacer 224, and the like. The transistor 205D is provided in the circuit portion 173, and the transistors 205R and 205G are provided in the display portion 162. The conductive layers 112b included in the transistors 205R and 205G are electrically connected to a pixel electrode 111 of a liquid crystal element 60.

The substrate 152 is provided with the coloring layers 132R and 132G, the light-blocking layer 117, an insulating layer 225, and the like.

Each of the transistors 205D, 205R, and 205G includes the conductive layer 112a, the conductive layer 112b, the semiconductor layer 108, the conductive layer 107, the conductive layer 109, the insulating layer 106, the conductive layer 104, and the like. The conductive layer 112a functions as one of a source electrode and a drain electrode, and the conductive layer 112b serves as the other. The conductive layer 107 functions as one of a source electrode and a drain electrode, and the conductive layer 109 serves as the other. The conductive layer 104 functions as a gate electrode. Part of the insulating layer 106 functions as a gate insulating layer.

The transistors 205D, 205R, and 205G are covered with the insulating layer 218. The insulating layer 218 functions as a protective layer for the transistors 205D, 205R, and 205G.

A subpixel included in the display portion 162 includes a transistor, the liquid crystal element 60, and a coloring layer. For example, a subpixel that emits red light includes the transistor 205R, the liquid crystal element 60, and the coloring layer 132R that transmits red light. A subpixel that emits green light includes the transistor 205G, the liquid crystal element 60, and the coloring layer 132G that transmits green light. Similarly, although not illustrated, a subpixel that emits blue light includes a transistor, the liquid crystal element 60, and a coloring layer that transmits blue light.

The liquid crystal element 60 includes the common electrode 115, the pixel electrode 111, and the liquid crystal 262. The common electrode 115 is provided over the insulating layer 218, and an insulating layer 214 is provided over the common electrode 115. The pixel electrode 111 is provided over the insulating layer 214.

The pixel electrode 111 and the common electrode 115 transmit visible light. That is, the display device 100D can be a transmissive liquid crystal display device. For example, in the case where a backlight is provided on the substrate 151 side, light from the backlight which is polarized by the polarizing plate 260b passes through the substrate 151, the liquid crystal element 60, and the substrate 152, and then reaches the polarizing plate 260a. In that case, alignment of the liquid crystal 262 is controlled with a voltage that is applied between the pixel electrode 111 and the common electrode 115, and thus optical modulation of light can be controlled. In other words, the intensity of light emitted through the polarizing plate 260a can be controlled. Light other than one in a particular wavelength region of the incident light is absorbed by the coloring layer, and thus, emitted light is red light, for example.

As the polarizing plate 260a, a linear polarizing plate or a circularly polarizing plate can be used. An example of a circularly polarizing plate is a stack including a linear polarizing plate and a quarter-wave retardation plate. Reflection of external light can be reduced with a circularly polarizing plate used as the polarizing plate 260a.

In the case where a circularly polarizing plate is used as the polarizing plate 260a, a circularly polarizing plate or a general linear polarizing plate may be used as the polarizing plate 260b. The cell gap, alignment, driving voltage, and the like of the liquid crystal element used as the liquid crystal element 60 can be controlled in accordance with the kinds of polarizing plates used as the polarizing plates 260a and 260b so that desirable contrast can be obtained.

The connection portion 204 is provided in a region near an end portion of the substrate 151. In the connection portion 204, the wiring 165 is electrically connected to the FPC 172 through the conductive layer 166 and the connection layer 242. The wiring 165 is electrically connected to the wiring 165 through an opening provided in the insulating layer 110. In the structure example illustrated in FIG. 17, the wiring 165 is formed using the same material in the same process as the conductive layers 112a and 107, and the conductive layer 166 is formed using the same material in the same process as the conductive layer 112b.

In a plan view, the pixel electrode 111 has a comb-like shape or a shape with a slit. Furthermore, the pixel electrode 111 is provided to overlap with the common electrode 115. There is a portion where the pixel electrode 111 is not provided over the common electrode 115 in a region overlapping with the coloring layer.

Note that in the liquid crystal element 60, both the pixel electrode 111 and the common electrode 115 may have a comb-like top surface shape. Meanwhile, as illustrated in the display device 100D, only one of the pixel electrode 111 and the common electrode 115 has a comb-like top surface shape in the liquid crystal element 60, whereby the pixel electrode 111 and the common electrode 115 partly overlap with each other. In this structure, capacitance between the pixel electrode 111 and the common electrode 115 can be used as a storage capacitor, and thus a capacitor does not need to be provided additionally; therefore, the aperture ratio of the display device can be increased.

The insulating layer 225 is provided on the substrate 152 side to cover the coloring layers 132R and 132G and the light-blocking layer 117. The insulating layer 225 functions as an overcoat that prevents diffusion of components contained in the coloring layers 132R and 132G and the like into the liquid crystal 262. In addition, the insulating layer 225 may have a function of a planarization film. The insulating layer 225 can be formed using a light-transmitting organic resin.

Alignment films for controlling the alignment of the liquid crystal 262 may be provided on surfaces of the pixel electrode 111, the insulating layer 214, the insulating layer 225, and the like which are in contact with the liquid crystal 262.

The above is the description of the structure examples of the display device.

### [Manufacturing Method Example of Display Device]

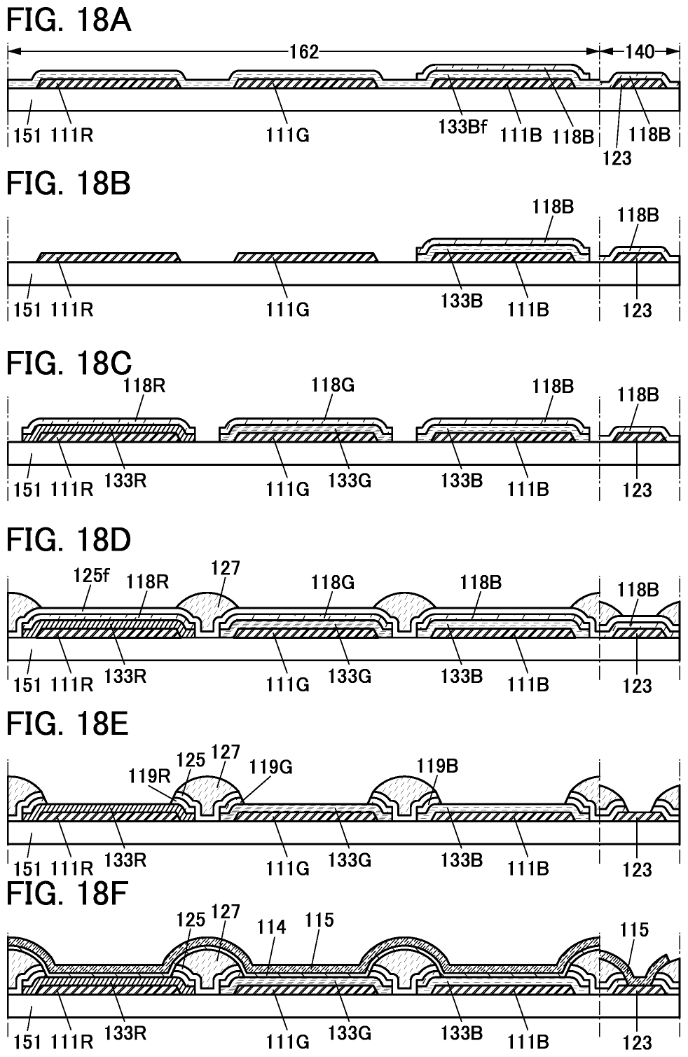

A method for manufacturing a display device having a metal maskless (MML) structure will be described below. Here, the process of manufacturing light-emitting elements without using a fine metal mask will be described in detail. FIGS. 18A to 18F are cross-sectional views of three light-emitting elements included in the display portion 162 and the connection portion 140 in the manufacturing steps.

For manufacture of the light-emitting elements, a vacuum process such as an evaporation method and a solution process such as a spin coating method or an inkjet method can be used. Examples of an evaporation method include physical vapor deposition methods (PVD methods) such as a sputtering method, an ion plating method, an ion beam evaporation method, a molecular beam evaporation method, and a vacuum evaporation method, and a chemical vapor deposition method (CVD method). Specifically, functional layers (e.g., a hole-injection layer, a hole-transport layer, a hole-blocking layer, a light-emitting layer, an electron-blocking layer, an electron-transport layer, an electron-injection layer, and a charge-generation layer) included in the EL layer can be formed by an evaporation method (e.g., a vacuum evaporation method), a coating method (e.g., a dip coating method, a die coating method, a bar coating method, a spin coating method, or a spray coating method), a printing method (e.g., ink-jetting, screen printing (stencil), offset printing (planography), flexography (relief printing), gravure printing, or micro-contact printing), or the like.

In the method described below for manufacturing the display device, the island-shaped layer (the layer including the light-emitting layer) is formed not by using a fine metal mask but by forming a light-emitting layer on the entire surface and processing the light-emitting layer by a photolithography method. Accordingly, a high-resolution display device or a display device with a high aperture ratio, which has been difficult to be formed so far, can be obtained. Moreover, light-emitting layers can be formed separately for the respective colors, enabling the display device to perform extremely clear display with high contrast and high display quality. Moreover, providing a sacrificial layer over the light-emitting layer can reduce damage to the light-emitting layer in the manufacturing process of the display device, resulting in an increase in reliability of the light-emitting element.

For example, in the case where the display device includes three kinds of light-emitting elements, which are a light-emitting element that emits blue light, a light-emitting element that emits green light, and a light-emitting element that emits red light, three kinds of island-shaped light-emitting layers can be formed by forming a light-emitting layer and performing processing three times by photolithography.

First, the pixel electrodes 111R, 111G, and 111B and the conductive layer 123 are formed over the substrate 151 provided with the transistors 205R, 205G, and 205B and the like (not illustrated) (FIG. 18A).

A conductive film to be the pixel electrodes can be formed by a sputtering method or a vacuum evaporation method, for example. A resist mask is formed over the conductive film by a photolithography process, and then the conductive film is processed, whereby the pixel electrodes 111R, 111G, and 111B and the conductive layer 123 can be formed. The conductive film can be processed by a wet etching method and/or a dry etching method.

Next, a film 133Bf to be the layer 133B later is formed over the pixel electrodes 111R, 111G, and 111B (FIG. 18A). The film 133Bf (to be the layer 133B later) includes a light-emitting layer that emits blue light.

In an example described in this embodiment, an island-shaped EL layer included in the light-emitting element that emits blue light is formed first, and then island-shaped EL layers included in the light-emitting elements that emit light of the other colors are formed.

In the formation process of the island-shaped EL layers, the pixel electrode of the light-emitting element of the color formed second or later is sometimes damaged by the preceding step. In this case, the driving voltage of the light-emitting element of the color formed second or later might be high.

In view of this, in manufacture of the display device of one embodiment of the present invention, it is preferable that an island-shaped EL layer of a light-emitting element that emits light with the shortest wavelength (e.g., the blue-light-emitting element) be formed first. For example, it is preferable that the island-shaped EL layers be formed for the blue-, green-, and red-light-emitting elements in this order or the blue-, red-, and green-light-emitting elements in this order.

This enables the blue-light-emitting element to keep the favorable state of the interface between the pixel electrode and the EL layer and to be inhibited from having an increased driving voltage. In addition, the blue-light-emitting element can have a longer lifetime and higher reliability. Note that the red-light-emitting element and the green-light-emitting element have a smaller increase in driving voltage or the like than the blue-light-emitting element, resulting in a lower driving voltage and higher reliability of the whole display device.

Note that the formation order of the island-shaped EL layers is not limited to the above; for example, the island-shaped EL layers may be formed for the red-, green-, and blue-light-emitting elements in this order.

As illustrated in FIG. 18A, the film 133Bf is not formed over the conductive layer 123. The film 133Bf can be deposited only in a desired region using an area mask, for example. Employing a deposition process using an area mask and a processing process using a resist mask enables a light-emitting element to be manufactured by a relatively easy process.

The upper temperature limit of the compounds contained in the film 133Bf is preferably higher than or equal to 100° C. and lower than or equal to 180° C., further preferably higher than or equal to 120° C. and lower than or equal to 180° C., still further preferably higher than or equal to 140° C. and lower than or equal to 180° C. Thus, the reliability of the light-emitting element can be increased. In addition, the allowable upper limit of the temperature that can be applied in the manufacturing process of the display device can be increased. Therefore, the range of choices of the materials and the manufacturing method of the display device can be widened, thereby improving the manufacturing yield and the reliability.

Examples of the upper temperature limit include the glass transition point, the softening point, the melting point, the thermal decomposition temperature, and the 5% weight loss temperature, and the lowest one among the temperatures is preferable.

The film 133Bf can be formed by an evaporation method, specifically a vacuum evaporation method, for example. The film 133Bf may be formed by a transfer method, a printing method, an inkjet method, a coating method, or the like.

Next, a sacrificial layer 118B is formed over the film 133Bf and the conductive layer 123 (FIG. 18A). A resist mask is formed over a film to be the sacrificial layer 118B by a photolithography process, and then the film is processed, whereby the sacrificial layer 118B can be formed.

Providing the sacrificial layer 118B over the film 133Bf can reduce damage to the film 133Bf in the manufacturing process of the display device, resulting in an increase in reliability of the light-emitting element.

The sacrificial layer 118B is preferably provided to cover the end portions of the pixel electrodes 111R, 111G, and 111B. Accordingly, the end portion of the layer 133B formed in a later step is positioned outward from the end portion of the pixel electrode 111B. The entire top surface of the pixel electrode 111B can be used as a light-emitting region, so that the aperture ratio of the pixel can be increased. The end portion of the layer 133B might be damaged in a step after the formation of the layer 133B, and thus is preferably positioned outward from the end portion of the pixel electrode 111B, i.e., not used as the light-emitting region. This can reduce a variation in the characteristics of the light-emitting elements and can improve reliability.

When the layer 133B covers the top and side surfaces of the pixel electrode 111B, the steps after the formation of the layer 133B can be performed without exposing the pixel electrode 111B. When the end portion of the pixel electrode 111B is exposed, corrosion might occur in the etching step or the like. When corrosion of the pixel electrode 111B is inhibited, the yield and characteristics of the light-emitting element can be improved.

The sacrificial layer 118B is preferably provided also at a position overlapping with the conductive layer 123. This can inhibit the conductive layer 123 from being damaged during the manufacturing process of the display device.

As the sacrificial layer 118B, a film that is highly resistant to the process conditions for the film 133Bf, specifically, a film that can have high etching selectivity with respect to the film 133Bf is used.

The sacrificial layer 118B is formed at a temperature lower than the upper temperature limit of each compound included in the film 133Bf. The typical substrate temperature in the formation of the sacrificial layer 118B is lower than or equal to 200° C., preferably lower than or equal to 150° C., further preferably lower than or equal to 120° C., still further preferably lower than or equal to 100° C., yet still further preferably lower than or equal to 80° C.

The upper temperature limit of the compound included in the film 133Bf is preferably high, in which case the deposition temperature of the sacrificial layer 118B can be high. For example, the substrate temperature in formation of the sacrificial layer 118B can be higher than or equal to 100° C., higher than or equal to 120° C., or higher than or equal to 140° C. An inorganic insulating film formed at a higher temperature can be denser and have a better barrier property. Therefore, forming the sacrificial layer at such a temperature can further reduce damage to the film 133Bf and improve the reliability of the light-emitting element.

Note that the same can be applied to the deposition temperature of another layer formed over the film 133Bf (e.g., an insulating film 125f).

The sacrificial layer 118B can be formed by a sputtering method, an ALD method (including a thermal ALD method and a PEALD method), a CVD method, or a vacuum evaporation method, for example. Alternatively, the sacrificial layer 118B may be formed by the above-described wet process.

The sacrificial layer 118B (or a layer that is in contact with the film 133Bf in the case where the sacrificial layer 118B has a stacked-layer structure) is preferably formed by a formation method that causes less damage to the film 133Bf. For example, the sacrificial layer 118B is preferably formed by an ALD method or a vacuum evaporation method rather than a sputtering method.

The sacrificial layer 118B can be processed by a wet etching method or a dry etching method. The sacrificial layer 118B is preferably processed by anisotropic etching.

In the case of employing a wet etching method, damage to the film 133Bf in processing of the sacrificial layer 118B can be reduced as compared to the case of employing a dry etching method. In the case of employing a wet etching method, it is preferable to use a developer, a tetramethylammonium hydroxide (TMAH) aqueous solution, dilute hydrofluoric acid, oxalic acid, phosphoric acid, acetic acid, nitric acid, or a mixed solution containing two or more of these acids, for example. In the case of employing a wet etching method, a mixed acid chemical solution containing water, phosphoric acid, diluted hydrofluoric acid, and nitric acid may be used. A chemical solution used for the wet etching treatment may be alkaline or acid.

As the sacrificial layer 118B, one or more of a metal film, an alloy film, a metal oxide film, a semiconductor film, an inorganic insulating film, and an organic insulating film can be used, for example.

For the sacrificial layer 118B, a metal material such as gold, silver, platinum, magnesium, nickel, tungsten, chromium, molybdenum, iron, cobalt, copper, palladium, titanium, aluminum, yttrium, zirconium, or tantalum or an alloy material containing the metal material can be used, for example.

The sacrificial layer 118B can be formed using a metal oxide such as In—Ga—Zn oxide, indium oxide, In—Zn oxide, In—Sn oxide, indium titanium oxide (In—Ti oxide), indium tin zinc oxide (In—Sn—Zn oxide), indium titanium zinc oxide (In—Ti—Zn oxide), indium gallium tin zinc oxide (In—Ga—Sn—Zn oxide), or indium tin oxide containing silicon.

In addition, in place of gallium described above, the element M (M is one or more of aluminum, silicon, boron, yttrium, copper, vanadium, beryllium, titanium, iron, nickel, germanium, zirconium, molybdenum, lanthanum, cerium, neodymium, hafnium, tantalum, tungsten, and magnesium) may be used.

For example, a semiconductor material such as silicon or germanium can be used as a material with excellent compatibility with the semiconductor manufacturing process. Alternatively, an oxide or a nitride of the semiconductor material can be used. Alternatively, a non-metallic material such as carbon or a compound thereof can be used. Alternatively, a metal such as titanium, tantalum, tungsten, chromium, or aluminum, or an alloy containing one or more of these metals can be used. Alternatively, an oxide containing the above-described metal, such as titanium oxide or chromium oxide, or a nitride such as titanium nitride, chromium nitride, or tantalum nitride can be used.

For the sacrificial layer 118B, any of a variety of inorganic insulating films that can be used as the protective layer 131 can be used. In particular, an oxide insulating film is preferable because its adhesion to the film 133Bf is higher than that of a nitride insulating film. For example, an inorganic insulating material such as aluminum oxide, hafnium oxide, or silicon oxide can be used for the sacrificial layer 118B. For the sacrificial layer 118B, an aluminum oxide film can be formed by an ALD method, for example. An ALD method is preferably used, in which case damage to a base (in particular, the film 133Bf) can be reduced.

For example, a stacked-layer structure of an inorganic insulating film (e.g., an aluminum oxide film) formed by an ALD method and an inorganic film (e.g., an In—Ga—Zn oxide film, a silicon film, or a tungsten film) formed by a sputtering method can be employed for the sacrificial layer 118B.

Note that the same inorganic insulating film can be used for both the sacrificial layer 118B and the insulating layer 125 that is to be formed later. For example, an aluminum oxide film formed by an ALD method can be used for both the sacrificial layer 118B and the insulating layer 125. For the sacrificial layer 118B and the insulating layer 125, the same deposition condition may be used or different deposition conditions may be used. For example, when the sacrificial layer 118B is formed under conditions similar to those of the insulating layer 125, the sacrificial layer 118B can be an insulating layer having a good barrier property against at least one of water and oxygen. Meanwhile, since the sacrificial layer 118B is a layer a large part or the whole of which is to be removed in a later step, it is preferable that the processing of the sacrificial layer 118B be easy. Therefore, the sacrificial layer 118B is preferably formed with a substrate temperature lower than that for formation of the insulating layer 125.

An organic material may be used for the sacrificial layer 118B. For example, as the organic material, a material that can be dissolved in a solvent chemically stable with respect to at least the uppermost film of the film 133Bf may be used. Specifically, a material that is dissolved in water or alcohol can be suitably used. In forming a film of such a material, it is preferable to apply the material dissolved in a solvent such as water or alcohol by a wet process and then perform heat treatment for evaporating the solvent. At this time, the heat treatment is preferably performed under a reduced-pressure atmosphere, in which case the solvent can be removed at a low temperature in a short time and thermal damage to the film 133Bf can be accordingly reduced.

The sacrificial layer 118B may be formed using an organic resin such as polyvinyl alcohol (PVA), polyvinyl butyral, polyvinylpyrrolidone, polyethylene glycol, polyglycerin, pullulan, water-soluble cellulose, an alcohol-soluble polyamide resin, or a fluororesin like perfluoropolymer.

For example, a stacked-layer structure of an organic film (e.g., a PVA film) formed by an evaporation method or the above wet process and an inorganic film (e.g., a silicon nitride film) formed by a sputtering method can be employed for the sacrificial layer 118B.

Note that in the display device of one embodiment of the present invention, part of the sacrificial film remains as the sacrificial layer in some cases.

Then, the film 133Bf is processed using the sacrificial layer 118B as a hard mask to form the layer 133B (FIG. 18B).

Accordingly, as illustrated in FIG. 18B, the stacked-layer structure of the layer 133B and the sacrificial layer 118B remains over the pixel electrode 111B. In addition, the pixel electrodes 111R and 111G are exposed. In a region corresponding to the connection portion 140, the sacrificial layer 118B remains over the conductive layer 123.

The film 133Bf is preferably processed by anisotropic etching. Anisotropic dry etching is particularly preferable. Alternatively, wet etching may be employed.

After that, steps similar to the formation step of the film 133Bf, the formation step of the sacrificial layer 118B, and the formation step of the layer 133B are repeated twice under the condition where at least light-emitting substances are changed, whereby a stacked-layer structure of the layer 133R and a sacrificial layer 118R is formed over the pixel electrode 111R and a stacked-layer structure of the layer 133G and a sacrificial layer 118G is formed over the pixel electrode 111G (FIG. 18C). Specifically, the layer 133R and the layer 133G are formed to include a light-emitting layer that emits red light and a light-emitting layer that emits green light, respectively. The sacrificial layers 118R and 118G can be formed using a material that can be used for the sacrificial layer 118B. The sacrificial layers 118R and 118G may be formed using the same material or different materials.

Note that the side surfaces of the layers 133B, 133G, and 133R are preferably perpendicular or substantially perpendicular to their formation surfaces. For example, the angles between the formation surfaces and these side surfaces are each preferably greater than or equal to 60° and less than or equal to 90°.

As described above, the distance between two adjacent layers among the layers 133B, 133G, and 133R formed by a photolithography method can be shortened to less than or equal to 8 μm, less than or equal to 5 μm, less than or equal to 3 μm, less than or equal to 2 μm, or less than or equal to 1 μm. Here, the distance can be determined by, for example, the distance between opposite end portions of two adjacent layers among the layers 133B, 133G, and 133R. When the distance between the island-shaped EL layers is shortened in this manner, a high-resolution display device with a high aperture ratio can be provided.

Next, the insulating film 125f to be the insulating layer 125 later is formed to cover the pixel electrodes, the layers 133B, 133G, and 133R, and the sacrificial layers 118B, 118G, and 118R, and then the insulating layer 127 is formed over the insulating film 125f (FIG. 18D).

The insulating film 125f is preferably formed to have a thickness greater than or equal to 3 nm, greater than or equal to 5 nm, or greater than or equal to 10 nm and less than or equal to 200 nm, less than or equal to 150 nm, less than or equal to 100 nm, or less than or equal to 50 nm.

The insulating film 125f is preferably formed by an ALD method, for example. An ALD method is preferably used, in which case deposition damage is reduced and a film with good coverage can be formed. As the insulating film 125f, an aluminum oxide film is preferably formed by an ALD method, for example.

Alternatively, the insulating film 125f may be formed by a sputtering method, a CVD method, or a plasma CVD method that provides a higher deposition rate than an ALD method. In this case, a highly reliable display device can be manufactured with high productivity.

For example, an insulating film to be the insulating layer 127 is preferably formed by the aforementioned wet process (e.g., spin coating) using a photosensitive resin composite containing an acrylic resin. After the formation, heat treatment (also referred to as pre-baking) is preferably performed to eliminate a solvent contained in the insulating film. Next, part of the insulating film is irradiated with visible light or ultraviolet rays as light exposure. Next, the region of the insulating film exposed to light is removed by development. Then, heat treatment (also referred to as post-baking) is performed. Accordingly, the insulating layer 127 illustrated in FIG. 18D can be formed. Note that the shape of the insulating layer 127 is not limited to that illustrated in FIG. 18D. For example, the top surface of the insulating layer 127 can include one or more of a convex surface, a concave surface, and a flat surface. The insulating layer 127 may cover the side surface of an end portion of at least one of the insulating layer 125, the sacrificial layer 118B, the sacrificial layer 118G, and the sacrificial layer 118R.

Next, as illustrated in FIG. 18E, etching treatment is performed using the insulating layer 127 as a mask to remove portions of the insulating film 125f and the sacrificial layers 118B, 118G, and 118R. Consequently, openings are formed in the sacrificial layers 118B, 118G, and 118R, and the top surfaces of the layers 133B, 133G, and 133R and the conductive layer 123 are exposed. Note that portions of the sacrificial layers 118B, 118G, and 118R may remain in positions overlapping with the insulating layers 127 and 125 (see sacrificial layers 119B, 119G, and 119R).

The etching treatment can be performed by dry etching or wet etching. Note that the insulating film 125f is preferably formed using the same material as the sacrificial layers 118B, 118G, and 118R, in which case etching treatment can be performed collectively.

As described above, by providing the insulating layer 127, the insulating layer 125, and the sacrificial layers 118R, 118G, and 118B, poor connection due to a disconnected portion and an increase in electric resistance due to a locally thinned portion can be inhibited from occurring in the common layer 114 and the common electrode 115 between the light-emitting elements. Thus, the display device of one embodiment of the present invention can have improved display quality.

Next, the common layer 114 and the common electrode 115 are formed in this order over the insulating layer 127 and the layers 133B, 133G, and 133R (FIG. 18F).

The common layer 114 can be formed by an evaporation method (including a vacuum evaporation method), a transfer method, a printing method, an inkjet method, a coating method, or the like.

The common electrode 115 can be formed by a sputtering method or a vacuum evaporation method, for example. Alternatively, a film formed by an evaporation method and a film formed by a sputtering method may be stacked.

As described above, in the method for manufacturing the display device of one embodiment of the present invention, the island-shaped layers 133R, 133G, and 133B are formed not by using a fine metal mask but by forming a film on the entire surface and processing the film; thus, the island-shaped layers can be formed to have a uniform thickness. Consequently, a high-resolution display device or a display device with a high aperture ratio can be obtained. Furthermore, even when the resolution or the aperture ratio is high and the distance between the subpixels is extremely short, the layers 133R, 133G, and 133B can be inhibited from being in contact with each other in the adjacent subpixels. As a result, generation of a leakage current between the subpixels can be inhibited. This can prevent crosstalk-induced unintended light emission, so that a display device with extremely high contrast can be obtained.

The insulating layer 127 having a tapered end portion and being provided between adjacent island-shaped EL layers can prevent step disconnection and a locally thinned portion to be formed in the common electrode 115 at the time of forming the common electrode 115. Thus, a connection defect due to a disconnection portion and an increase in electric resistance due to a locally thinned portion can be inhibited from occurring in the common layer 114 and the common electrode 115. Hence, the display device of one embodiment of the present invention achieves both high resolution and high display quality.

The above is the description of the manufacturing method example of the display device.

At least part of this embodiment can be implemented in combination with any of the other embodiments described in this specification, as appropriate.

This application is based on Japanese Patent Application Serial No. 2023-069961 filed with Japan Patent Office on Apr. 21, 2023, the entire contents of which are hereby incorporated by reference.

What is claimed is:

1. An electronic device comprising:
a housing; and
a display panel having flexibility and provided in the housing,
wherein the display panel comprises a first display portion, a second display portion, a third display portion, and a first portion,
wherein the first display portion is on a front surface of the housing,
wherein the second display portion is seamlessly continuous with the first display portion and is on a first side surface of the housing,
wherein the third display portion is seamlessly continuous with the first display portion and is on a second side surface of the housing that is adjacent to the first side surface,
wherein the first portion faces the first display portion with the second display portion therebetween when the display panel is developed,
wherein the first portion is folded back to a back side of the first display portion, and
wherein the first portion comprises a terminal portion.

2. An electronic device comprising:
a housing; and
a display panel having flexibility and provided in the housing,
wherein the display panel comprises a first display portion, a second display portion, a third display portion, and a first portion,
wherein the first display portion is on a front surface of the housing,
wherein the second display portion is seamlessly continuous with the first display portion and is on a first side surface of the housing,
wherein the third display portion is seamlessly continuous with the first display portion and is on a second side surface of the housing that is adjacent to the first side surface,
wherein the first portion faces the first display portion with the second display portion therebetween when the display panel is developed,
wherein the first portion is folded back to a back side of the first display portion, and
wherein the first portion comprises a circuit portion.

3. The electronic device according to claim 2, wherein the circuit portion comprises one or more of a shift register circuit, a demultiplexer circuit, a latch circuit, and a level shifter circuit.

4. The electronic device according to claim 2, wherein the circuit portion comprises a signal line driver circuit.

5. The electronic device according to claim 1,
wherein the display panel comprises a fourth display portion,
wherein the fourth display portion is seamlessly continuous with the first display portion and is on a third side surface of the housing that is opposite to the first side surface and adjacent to the second side surface.

6. The electronic device according to claim 1,
wherein the display panel comprises a fifth display portion, and
wherein the fifth display portion is seamlessly continuous with the first display portion and is on a fourth side surface of the housing that is opposite to the second side surface and adjacent to the first side surface.

7. The electronic device according to claim 1,
wherein the second display portion comprises a portion curved with a first curvature,
wherein the third display portion comprises a portion curved with a second curvature, and
wherein the first curvature is different from the second curvature.

8. The electronic device according to claim 1,
wherein the second display portion comprises a portion curved with a first curvature,
wherein the third display portion comprises a portion curved with a second curvature, and
wherein the first curvature is larger than the second curvature.

9. The electronic device according to claim 1, wherein the first portion comprises a portion fixed to a rear surface of the first display portion.

10. The electronic device according to claim 1,
wherein the first display portion comprises a first pixel region, a second pixel region, and a third pixel region,
wherein the first pixel region comprises a plurality of pixels,
wherein the second pixel region comprises a plurality of pixels and a scan line driver circuit, and
wherein the third pixel region comprises a plurality of pixels and a signal line driver circuit.

11. The electronic device according to claim 1,
wherein the first display portion comprises a first pixel region and a second pixel region,
wherein the first pixel region comprises a plurality of pixels, and
wherein the second pixel region comprises a plurality of pixels and a scan line driver circuit.

12. The electronic device according to claim 1,
wherein the first portion comprises a sensor portion,
wherein the sensor portion comprises a pressure-sensitive sensor, and
wherein the first portion comprises a portion fixed so that the sensor portion is on a rear surface of the first display portion.

13. The electronic device according to claim 2, further comprising:
a radiator plate in the housing,
wherein the radiator plate is bonded to the first portion with a thermally conductive adhesive material.

14. The electronic device according to claim 13, further comprising:
a battery in the housing,
wherein the battery is bonded to the radiator plate with a thermally conductive adhesive material.

15. The electronic device according to claim 1,
wherein the first display portion comprises a plurality of pixels,
wherein each of the pixels comprises a display element and a transistor,
wherein the transistor comprises an oxide semiconductor in a semiconductor layer where a channel is formed, and
wherein a source and a drain of the transistor are at different heights.

16. The electronic device according to claim 15, wherein the semiconductor layer comprises at least one of In oxide, Ga oxide, Zn oxide, In—Zn oxide, In—Ga oxide, In—Sn oxide, In—Ti oxide, In—Ga—Al oxide, In—Ga—Sn oxide, In—Ga—Zn oxide, In—Sn—Zn oxide, In—Al—Zn oxide, In—Ti—Zn oxide, In—Ga—Sn—Zn oxide, and In—Ga—Al—Zn oxide.

17. The electronic device according to claim 2,
wherein the first display portion comprises a plurality of pixels,
wherein each of the pixels comprises a display element and a first transistor,
wherein the circuit portion comprises a second transistor,
wherein each of the first transistor and the second transistor comprises an oxide semiconductor in a semiconductor layer where a channel is formed, and
wherein a source and a drain of each of the first transistor and the second transistor are at different heights.

18. The electronic device according to claim 17, wherein the semiconductor layer comprises at least one of In oxide, Ga oxide, Zn oxide, In—Zn oxide, In—Ga oxide, In—Sn oxide, In—Ti oxide, In—Ga—Al oxide, In—Ga—Sn oxide, In—Ga—Zn oxide, In—Sn—Zn oxide, In—Al—Zn oxide, In—Ti—Zn oxide, In—Ga—Sn—Zn oxide, and In—Ga—Al—Zn oxide.

19. The electronic device according to claim 2,
wherein the display panel comprises a fourth display portion,
wherein the fourth display portion is seamlessly continuous with the first display portion and is on a third side surface of the housing that is opposite to the first side surface and adjacent to the second side surface.

20. The electronic device according to claim 2,
wherein the display panel comprises a fifth display portion, and
wherein the fifth display portion is seamlessly continuous with the first display portion and is on a fourth side surface of the housing that is opposite to the second side surface and adjacent to the first side surface.

21. The electronic device according to claim 2,
wherein the second display portion comprises a portion curved with a first curvature,
wherein the third display portion comprises a portion curved with a second curvature, and
wherein the first curvature is different from the second curvature.

22. The electronic device according to claim 2, wherein the first portion comprises a portion fixed to a rear surface of the first display portion.

23. The electronic device according to claim 2,
wherein the first display portion comprises a first pixel region and a second pixel region,
wherein the first pixel region comprises a plurality of pixels, and
wherein the second pixel region comprises a plurality of pixels and a scan line driver circuit.

24. The electronic device according to claim 2,
wherein the first portion comprises a sensor portion,
wherein the sensor portion comprises a pressure-sensitive sensor, and
wherein the first portion comprises a portion fixed so that the sensor portion is on a rear surface of the first display portion.

25. The electronic device according to claim 2,
wherein the first display portion comprises a plurality of pixels,
wherein each of the pixels comprises a display element and a transistor,
wherein the transistor comprises an oxide semiconductor in a semiconductor layer where a channel is formed, and
wherein a source and a drain of the transistor are at different heights.

26. The electronic device according to claim 25, wherein the semiconductor layer comprises at least one of In oxide, Ga oxide, Zn oxide, In—Zn oxide, In—Ga oxide, In—Sn oxide, In—Ti oxide, In—Ga—Al oxide, In—Ga—Sn oxide, In—Ga—Zn oxide, In—Sn—Zn oxide, In—Al—Zn oxide, In—Ti—Zn oxide, In—Ga—Sn—Zn oxide, and In—Ga—Al—Zn oxide.
